(19) United States
(12) Patent Application Publication
(10) Pub. No.: US 2026/0360316 A1
(43) Pub. Date: Nov. 12, 2026

(54) DISPLAY DEVICE AND ELECTRONIC DEVICE INCLUDING DISPLAY DEVICE

(71) Applicant: Samsung Display Co., Ltd., Yongin-si (KR)

(72) Inventors: Young Gu KANG, Yongin-si (KR); Min Ji KIM, Yongin-si (KR); Hyeon Do PARK, Yongin-si (KR); Hyun Sung PARK, Yongin-si (KR)

(21) Appl. No.: 19/397,738

(22) Filed: Nov. 21, 2025

(30) Foreign Application Priority Data
May 12, 2025 (KR) 10-2025-0061446

(51) Int. Cl. G09G 3/3266; G09G 3/32

(52) U.S. Cl. CPC G09G 3/3266; G09G 3/32; G09G 2300/0426; G09G 2310/0267; G09G 2330/06

(57) ABSTRACT

A display device includes a display including a first display area including a first pixel, a second display area including a second pixel, and a third display area including a third pixel, and a gate driver connected to the first pixel, to the second pixel, and to the third pixel via gate lines including a first gate line, a second gate line, a third gate line, a fourth gate line, and a fifth gate line defining two or more cut portions, extending in a first direction, and arranged along a second direction crossing the first direction, one of the gate lines connected to the third pixel having a longest length of the gate lines

### CROSS-REFERENCE TO RELATED APPLICATION

The present application claims priority to, and the benefit of, Korean Patent Application Number 10-2025-0061446, filed on May 12, 2025, in the Korean Intellectual Property Office, the entire disclosure of which is incorporated herein by reference.

### BACKGROUND

### 1. Field

Aspects of some embodiments of the present disclosure relate to a display device, and an electronic device including the display device.

### 2. Description of the Related Art

With the development of information technology, the importance of display devices, which provide a connection medium between users and information, has been emphasized. Owing to the importance of display devices, the use of various kinds of display devices, such as liquid crystal display devices, organic light-emitting display devices, and plasma display devices, has increased.

The above information disclosed in this Background section is only for enhancement of understanding of the background and therefore the information discussed in this Background section does not necessarily constitute prior art.

### SUMMARY

Aspects of some embodiments of the present disclosure include a display device and an electronic device including the display device, which may reduce or prevent damage to transistors caused by static electricity flowing into gate lines.

A display device according to some embodiments of the present disclosure includes a display including a first display area including a first pixel, a second display area including a second pixel, and a third display area including a third pixel, and a gate driver connected to the first pixel, to the second pixel, and to the third pixel via gate lines including a first gate line, a second gate line, a third gate line, a fourth gate line, and a fifth gate line defining two or more cut portions, extending in a first direction, and arranged along a second direction crossing the first direction, one of the gate lines connected to the third pixel having a longest length of the gate lines.

The third pixel may be at an outermost edge of the third display area facing the gate driver.

The first gate line, the second gate line, the third gate line, the fourth gate line, and the fifth gate line may include three or more branch gate lines respectively separated by the two or more cut portions.

The three or more branch gate lines may be separated by about 5μm to about 15μm in the first direction.

The two or more cut portions may be spaced apart in the first direction by a distance corresponding to a dimension of the third pixel.

A cut portion farthest from the gate driver among the two or more cut portions may be adjacent to the third pixel.

A cut portion farthest from the gate driver among the two or more cut portions may be separated from the third pixel in the first direction by distance corresponding to a multiple of a dimension of the third pixel.

A display device according to some embodiments of the present disclosure includes a display including a first display area including a first pixel, a second display area including a second pixel, and a third display area including a third pixel, and a gate driver connected to the first pixel, to the second pixel, and to the third pixel via gate lines including a first gate line, a second gate line, a third gate line, a fourth gate line, and a fifth gate line respectively defining a first cut portion and a second cut portion, extending in a first direction, and arranged along a second direction crossing the first direction, one of the gate lines connected to the third pixel having a longest length.

The first gate line, the second gate line, the third gate line, the fourth gate line, and the fifth gate line may include three branch gate lines separated by the first cut portion and the second cut portion.

The first gate line, the second gate line, the third gate line, the fourth gate line, and the fifth gate line may further define a third cut portion.

The first gate line, the second gate line, the third gate line, the fourth gate line, and the fifth gate line may include four branch gate lines respectively separated by the first cut portion, the second cut portion, and the third cut portion.

The first gate line, the second gate line, the third gate line, the fourth gate line, and the fifth gate line may further include a fourth cut portion.

The first gate line, the second gate line, the third gate line, the fourth gate line, and the fifth gate line may include five branch gate lines respectively separated by the first cut portion, the second cut portion, the third cut portion, and the fourth cut portion.

The first gate line, the second gate line, the third gate line, the fourth gate line, and the fifth gate line may further include a fifth cut portion.

The first gate line, the second gate line, the third gate line, the fourth gate line, and the fifth gate line may include six branch gate lines respectively separated by the first cut portion, the second cut portion, the third cut portion, the fourth cut portion, and the fifth cut portion.

The first cut portion may be farthest from the gate driver and adjacent to the third pixel.

The first cut portion may be farthest from the gate driver and may be separated from the third pixel by a distance corresponding to a multiple of a dimension of the third pixel in the first direction.

The third pixel may include a first transistor connected between a first node and a second node, and having a gate electrode connected to a third node, a second transistor connected between the first node and a data line, and having a gate electrode connected to the second gate line, a third transistor connected between the second node and the third node, and having a gate electrode connected to the second gate line, a fourth transistor connected between the third node and a first initialization line, and having a gate electrode connected to the first gate line, a fifth transistor connected between a fourth node and a first power line, and having a gate electrode connected to the third gate line, a sixth transistor connected between the second node and a fifth node, and having a gate electrode connected to the third gate line, a seventh transistor connected between the fifth node and a second initialization line, and having a gate electrode connected to the fifth gate line, an eighth transistor connected between the first node and the fourth node, and having a gate electrode connected to the third gate line, a ninth transistor connected between the fourth node and a third power line, and having a gate electrode connected to the fourth gate line, a capacitor connected between the third node and the fourth node, and a light-emitting element connected between the fifth node and a second power line.

In a plan view, the second transistor, the fourth transistor, the seventh transistor, the eighth transistor, and the ninth transistor may be at an outermost edge of the third pixel facing the gate driver.

An electronic device according to some embodiments of the present disclosure includes a processor configured to provide input image data, and a display device configured to display images based on the input image data, and including a display including a first display area including a first pixel, a second display area including a second pixel, and a third display area including a third pixel, and a gate driver connected to the first pixel, to the second pixel, and to the third pixel via gate lines including a first gate line, a second gate line, a third gate line, a fourth gate line, and a fifth gate line defining two or more cut portions, extending in a first direction, and arranged along a second direction crossing the first direction, one of the gate lines connected to the third pixel having a longest length.

### BRIEF DESCRIPTION OF THE DRAWINGS

FIG. 1 schematically illustrates a display device according to some embodiments of the present disclosure.

FIG. 2 schematically illustrates a display according to some embodiments of the present disclosure.

FIG. 3 illustrates an equivalent circuit of a pixel according to some embodiments of the present disclosure.

FIG. 4 is a schematic layout of a semiconductor layer according to some embodiments of the present disclosure.

FIG. 5 is a schematic layout of a first conductive layer according to some embodiments of the present disclosure.

FIG. 6 is a schematic layout of a second conductive layer according to some embodiments of the present disclosure.

FIG. 7 schematically illustrates a gate line according to some embodiments of the present disclosure.

FIGS. 8-11 schematically illustrate gate lines according to some embodiments of the present disclosure.

FIGS. 12-15 schematically illustrate gate lines according to some embodiments of the present disclosure.

FIG. 16 schematically illustrates a gate line according to some embodiments of the present disclosure.

FIG. 17 schematically illustrates gate lines and data lines according to some embodiments of the present disclosure.

FIG. 18 schematically illustrates an electronic device according to some embodiments of the present disclosure.

FIG. 19 schematically illustrates electronic devices according to some embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature’s relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When "C to D" is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer, or section described below could be termed a second element, component, region, layer, or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/- 5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.” Furthermore, the expression “being the same” may mean “being substantially the same.” In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

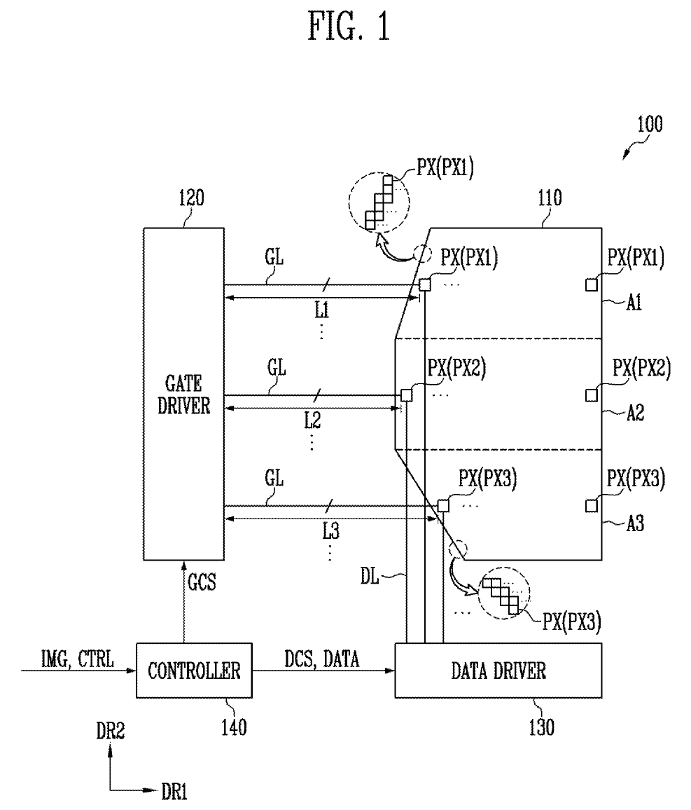

FIG. 1 schematically illustrates a display device according to some embodiments of the present disclosure.

Referring to FIG. 1, a display device 100 may include a display (e.g., a display unit or a pixel unit) 110, a gate driver 120, a data driver 130, and a controller 140.

The display 110 may be a display area that displays an image. In embodiments, the display 110 may be implemented as a non-structured, unstructured shape. For example, the display 110 may be implemented as a hexagon rather than a rectangle (or, square). In one or more embodiments, the display 110 may be implemented as the hexagon shown in FIG. 1. For example, a left side shape of the display 110 may be realized as a first diagonal, a straight line connected to the first diagonal, and a second diagonal connected to the straight line. The first diagonal may extend in a direction between a first direction DR1 and a second direction DR2 that crosses the first direction DR1. The straight line may extend in the second direction DR2. The second diagonal may extend in a direction between the first direction DR1 and an opposite direction of the second direction DR2. A slope of the first diagonal may be different from a slope of the second diagonal. For example, an obtuse angle formed by the first diagonal and a straight line may be larger than an obtuse angle formed by the second diagonal and a straight line. That is, in a two-dimensional plane defined by the first direction DR1 and the second direction DR2, the slope of the second diagonal may be less than the slope of the first diagonal. However, embodiments are not necessarily limited thereto. For example, the slope of the first diagonal may be the same as the slope of the second diagonal. For example, the slope of the first diagonal may be less than the slope of the second diagonal. In addition, the display 110 may also be implemented in an atypical shape other than a rectangle and a square, such as other rectangles as a trapezoid, polygons such as a pentagon, circles, ovals, etc.

In one or more embodiments, the display 110 may include a first display area A1, a second display area A2, and a third display area A3. The first display area A1 may have a trapezoidal shape. The second display area A2 may have a rectangular shape. The third display area A3 may have a trapezoidal shape. The second diagonal constituting the third display area A3 may be formed with a gentle slope compared to the first diagonal constituting the first display area A1.

The display 110 may include pixels PX. In one or more embodiments, the pixels PX may include first pixels PX1, second pixels PX2, and third pixels PX3. The first pixels PX1 may be located in the first display area A1. A left portion of the first display area A1 is schematically shown as diagonal, but in practice, the first pixels PX1 may be arranged in the form of a staircase. The second pixels PX2 may be arranged in the second display area A2. The third pixels PX3 may be arranged in the third display area A3. A left portion of the third display area A3 is schematically shown as diagonal, but in practice, the third pixel PX3 may be arranged in the form of a staircase. In the two-dimensional plane defined by the first direction DR1 and the second direction DR2, the slope based on a staircase shape of the third pixels PX3 may be less than the slope based on the staircase shape of the first pixels PX1. For example, the staircase shape of the third pixel PX3 may have a step corresponding to one third pixel PX3 and the staircase shape of the first pixel PX3 may have a step corresponding to two third pixels PX3. However, the embodiments are not necessarily limited thereto, and the step generated by the staircase shape may be varied.

In FIG. 1, a first pixel PX1 located at the outermost edge of the first display area A1 among the first pixels PX1 is representatively shown. For example, the first pixel PX1 located at the outermost edge of the first display area A1 may be a pixel PX located in a first pixel column facing the gate driver 120 located to the left of the display 110 among the pixels PX arranged in the first direction DR1 in any pixel row in the first display area A1. In FIG. 1, a second pixel PX2 located at the outermost edge of the second display area A2 among the second pixels PX2 is representatively shown. For example, the second pixel PX2 located at the outermost edge of the second display area A2 may be a pixel PX located in the first pixel column facing the gate driver 120 located to the left of the display 110 among the pixels PX arranged in the first direction DR1 in any pixel row in the second display area A2. In FIG. 1, a third pixel PX3 located at the outermost edge of the third display area A3 among the third pixels PX3 is representatively shown. For example, the third pixel PX3 located at the outermost edge of the third display area A3 may be a pixel PX located in the first pixel column facing the gate driver 120 located to the left of the display 110 among the pixels PX arranged in the first direction DR1 in any pixel row in the third display area A3. In the following, the description will refer to the first to third pixels PX1 to PX3 located at the outermost edge of the display 110 described above.

However, embodiments are not necessarily limited thereto. In embodiments, the gate driver 120 may be located to the right of the display 110. In this case, the first pixel PX1 located at the outermost edge of the first display area A1 may be the pixel PX located in the last pixel column facing the gate driver 120 located to the right of the display 110 among the pixels PX arranged in the first direction DR1 in any pixel row in the first display area A1. The second pixel PX2 located at the outermost edge of the second display area A2 may be a pixel PX located in the last pixel column facing the gate driver 120 located to the right of the display 110 among the pixels PX arranged in the first direction DR1 in any pixel row in the second display area A2. The third pixel PX3 located at the outermost edge of the third display area A3 may be a pixel PX located in the last pixel column facing the gate driver 120 located to the right of the display 110 among the pixels PX arranged in the first direction DR1 in any pixel row in the third display area A3.

In one or more embodiments, the gate driver 120 may be implemented as two gate drivers, such as a first gate driver and a second gate driver. The first gate driver may be located to the left of the display 110 and the second gate driver may be located to the right of the display 110. In this case, the first pixels PX1 located at the outermost edge of the first display area A1 may be located in the first pixel column facing the first gate driver and in the last pixel column facing the second gate driver in any pixel row in the first display area A1, respectively. The second pixels PX2 located at the outermost edge of the second display area A2 may be located in the first pixel column facing the first gate driver and in the last pixel column facing the second gate driver in any pixel row of the second display area A2, respectively. The third pixels PX3 located at the outermost edge of the third display area A3 may be located in the first pixel column facing the first gate driver and in the last pixel column facing the second gate driver in any pixel row of the third display area A3, respectively.

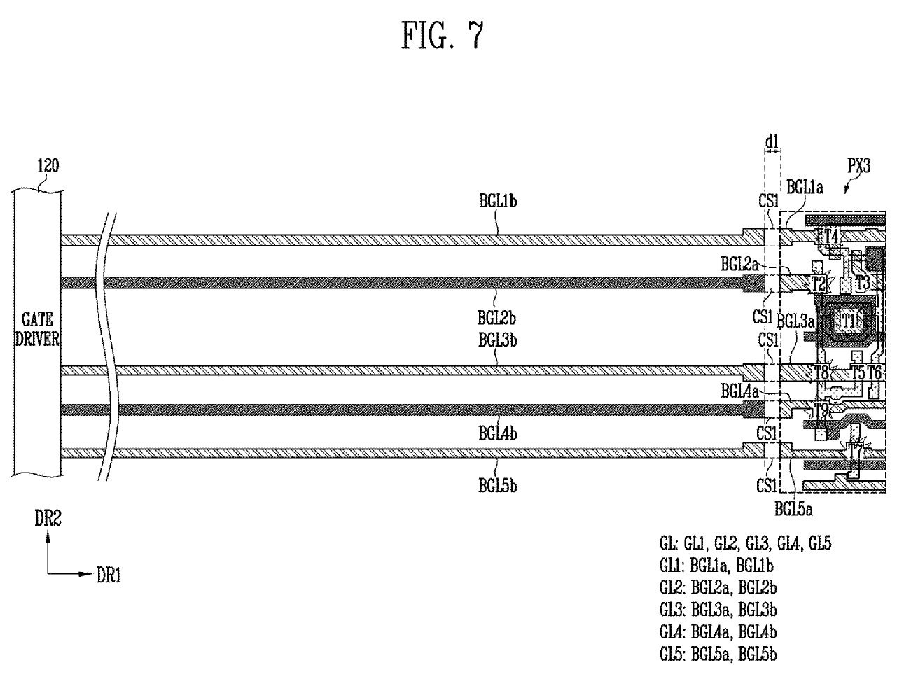

The first to third pixels PX1 to PX3 may each be connected to a corresponding gate line GL. In one or more embodiments, the gate lines GL connected to the first and third pixels PX1 to PX3 may have different lengths. For example, the gate line GL connected to the first pixel PX1 may have a first length L1. For example, the gate line GL connected to the second pixel PX2 may have a second length L2. For example, the gate line GL connected to the third pixel PX3 may have a third length L3. The third length L3 may be longer than the first length L1. The first length L1 may be longer than the second length L2. That is, the third length L3 of the gate line GL connected to the third pixel PX3 may be relatively the longest. In FIG. 1, the gate driver 120 is shown in a rectangular shape for convenience, but the gate driver 120 may have an atypical shape corresponding to the atypical shape of the display 110. Accordingly, the gate lines GL connected to the first pixels PX1 located at the outermost edge of the first display area A1 may have the same first length L1. Further, the gate lines GL connected to the second pixels PX2 located at the outermost edge of the second display area A2 may have the same second length L2. Further, the gate lines GL connected to the third pixels PX3 located at the outermost edge of the third display area A3 may have the same third length L3. As such, when the display 110 is implemented in an atypical shape, the lengths of the gate lines GL may deviate. Phenomena caused by length deviations will be discussed later with reference to FIG. 7.

The gate driver 120 may be located on one side of the display 110. For example, the gate driver 120 may be located on the left side of the display 110, but embodiments are not necessarily limited thereto. The position of the gate driver 120 may vary depending on the geometry of the display 110. The gate driver 120 may be connected to the first to third pixels PX1 to PX3 via the gate lines GL. The gate lines GL may extend in the first direction DR1 and may be arranged along the second direction DR2. The gate driver 120 may receive a gate control signal GCS. The gate driver 120 may output gate signals to the gate lines GL based on the gate control signal GCS.

The data driver 130 may be connected to the first to third pixels PX1 to PX3 via data lines DL. The data lines DL may extend in the second direction DR2 and may be arranged in the first direction DR1. The data driver 130 may receive data control signals DCS and image data DATA. The data driver 130 may output data signals corresponding to the image data DATA on the data lines DL based on the data control signal DCS.

The controller 140 may receive input image data IMG and a control signal CTRL from an external device, such as a processor. The controller 140 may generate the gate control signal GCS and the data control signal DCS based on the control signal CTRL. The controller 140 may convert the input image data IMG to image data DATA.

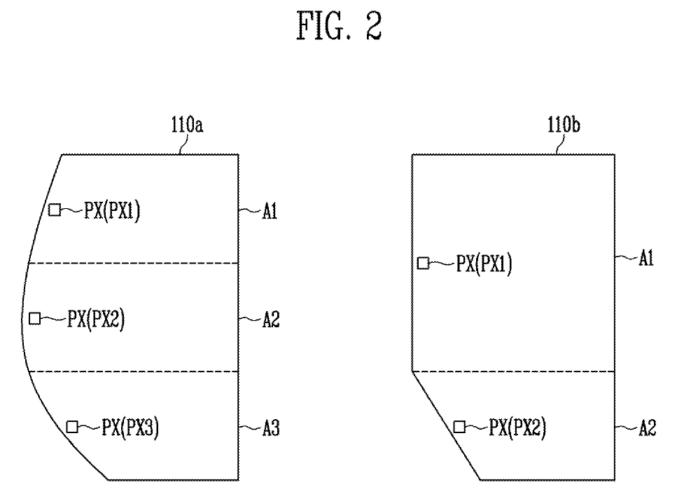

FIG. 2 schematically illustrates a display according to some embodiments of the present disclosure. In FIG. 2, previously described content is briefly explained or omitted.

Referring to FIG. 2, a portion of the display 110a may be implemented as a curved shape. For example, a shape of a left side of the display 110a may be implemented as a curved shape. A curve constituting the third display area A3 may have a smaller slope than a curve constituting the first display area A1 in the same section. That is, the curve forming the third display area A3 may have a smaller curvature than the curve forming the first display area A1, and may be formed relatively gently. Due to the atypical shape of the display 110a, a length of a gate line connected to the third pixel PX3 may be longer than a length of gate lines connected to the first and second pixels PX1 and PX2.

The display 110b may be implemented as a pentagon. For example, the left side of the display 110b may be realized as a straight line and a diagonal line connected to the straight line. The display 110b may include a first display area A1 including a first pixel PX1 and a second display area A2 including a second pixel PX2. Due to the atypical shape of the display 110b, a length of a gate line connected to the second pixel PX2 may be longer than a length of a gate line connected to the first pixel PX1.

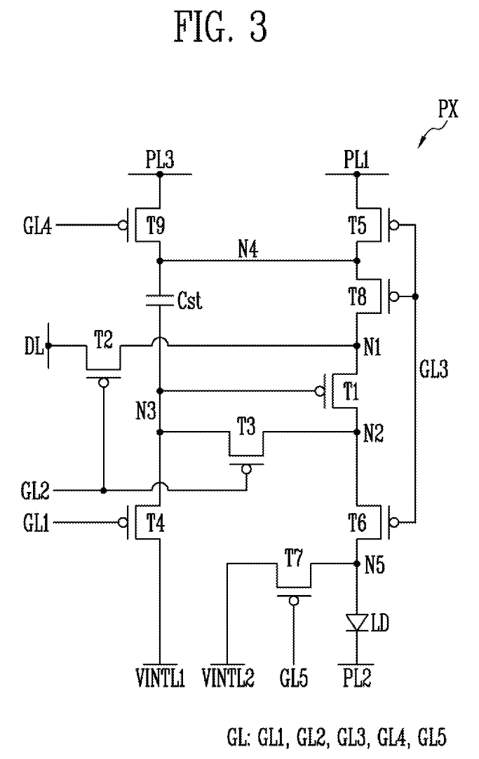

FIG. 3 illustrates an equivalent circuit of a pixel according to some embodiments of the present disclosure.

Referring to FIG. 3, the pixel PX may include a first transistor T1, a second transistor T2, a third transistor T3, a fourth transistor T4, a fifth transistor T5, a sixth transistor T6, a seventh transistor T7, an eighth transistor T8, a ninth transistor T9, a capacitor Cst, and a light-emitting element LD. The pixel PX may be connected to a gate line GL. The gate line GL may include a first gate line GL1, a second gate line GL2, a third gate line GL3, a fourth gate line GL4, and a fifth gate line GL5.

The first transistor T1 may be connected between a first node N1 and a second node N2. A gate electrode of the first transistor T1 may be connected to a third node N3. The first transistor T1 may be turned on in response to a voltage level at the third node N3.

The second transistor T2 may be connected between the first node N1 and a data line DL. A gate electrode of the second transistor T2 may be connected to the second gate line GL2. The second transistor T2 may be turned on depending on a voltage level of a gate signal supplied to the second gate line GL2.

The third transistor T3 may be connected between the second node N2 and the third node N3. A gate electrode of the third transistor T3 may be connected to the second gate line GL2. The third transistor T3 may be turned on depending on the voltage level of the gate signal supplied to the second gate line GL2.

The fourth transistor T4 may be connected between the third node N3 and a first initialization line VINTL1. A gate electrode of the fourth transistor T4 may be connected to the first gate line GL1. The fourth transistor T4 may be turned on depending on a voltage level of a gate signal supplied to the first gate line GL1.

The fifth transistor T5 may be connected between a fourth node N4 and a first power line PL1. A first power voltage having a positive voltage level may be supplied to the first power line PL1. A gate electrode of the fifth transistor T5 may be connected to the third gate line GL3. The fifth transistor T5 may be turned on in response to a voltage level of a gate signal supplied to the third gate line GL3.

The sixth transistor T6 may be connected between the second node N2 and a fifth node N5. A gate electrode of the sixth transistor T6 may be connected to the third gate line GL3. The sixth transistor T6 may be turned on depending on the voltage level of the gate signal supplied to the third gate line GL3.

The seventh transistor T7 may be connected between the fifth node N5 and a second initialization line VINTL2. A gate electrode of the seventh transistor T7 may be connected to the fifth gate line GL5. The seventh transistor T7 may be turned on depending on a voltage level of a gate signal supplied to the fifth gate line GL5.

The eighth transistor T8 may be connected between the first node N1 and the fourth node N4. A gate electrode of the eighth transistor T8 may be connected to the third gate line GL3. The eighth transistor T8 may be turned on according to a voltage level of the gate signal supplied to the third gate line GL3.

The ninth transistor T9 may be connected between the fourth node N4 and a third power line PL3. A third power voltage having the same or similar voltage level as the first power voltage may be supplied to the third power line PL3. A gate electrode of the ninth transistor T9 may be connected to the fourth gate line GL4. The ninth transistor T9 may be turned on in response to a voltage level of a gate signal supplied to the fourth gate line GL4.

The first to ninth transistors T1 to T9 may be a metal oxide silicon field effect transistor (MOSFET). The first to ninth transistors T1 to T9 may be implemented as a P-type transistor. However, embodiments are not necessarily limited thereto. For example, at least one of the first to ninth transistors T1 to T9 may be implemented as an N-type transistor. The first to ninth transistors T1 to T9 may include an amorphous silicon semiconductor, a monocrystalline silicon semiconductor, polycrystalline silicon semiconductor, oxide semiconductor, and the like.

The capacitor Cst may be connected between the third node N3 and the fourth node N4.

The light-emitting element LD may be connected between the fifth node N5 and a second power line PL2. A second power voltage having a voltage level that is lower than the first power voltage may be supplied to the second power line PL2. The light-emitting element LD may include an organic light-emitting diode, an inorganic light-emitting diode, or the like.

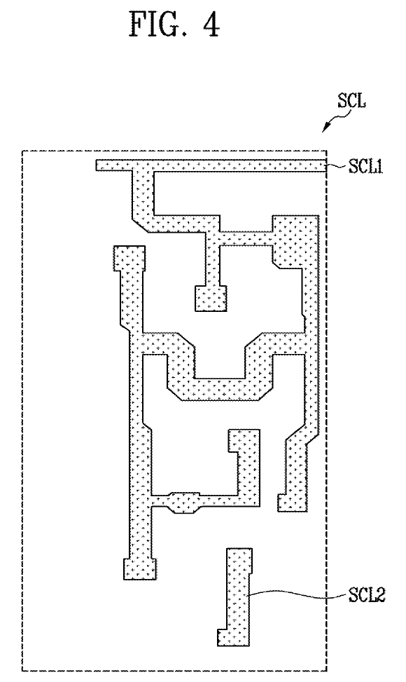

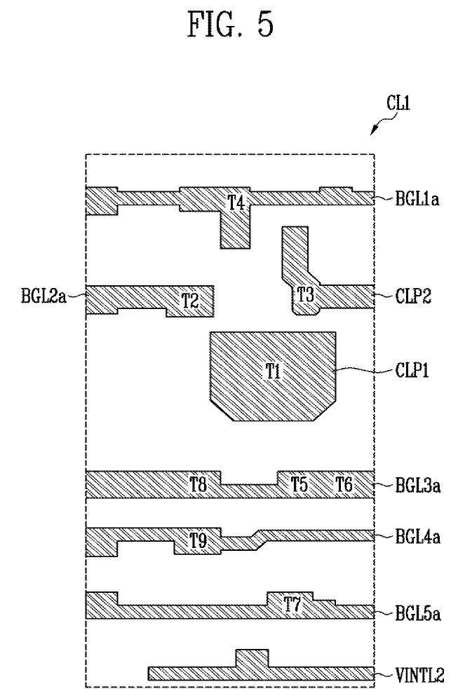

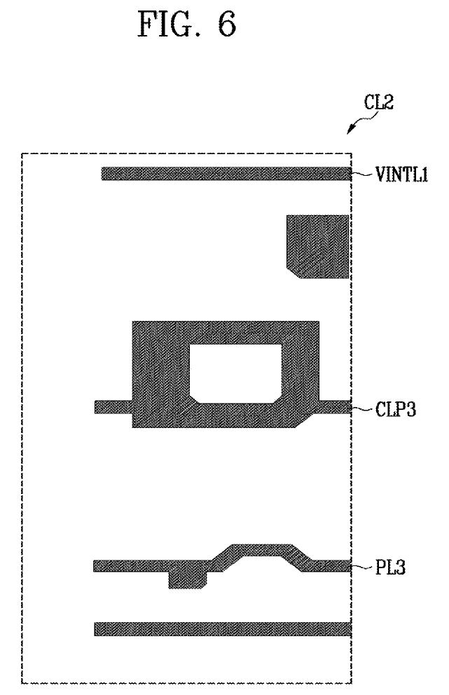

FIG. 4 is a schematic layout of a semiconductor layer according to some embodiments of the present disclosure. FIG. 5 is a schematic layout of a first conductive layer according to some embodiments of the present disclosure. FIG. 6 is a schematic layout of a second conductive layer according to some embodiments of the present disclosure.

Referring to FIG. 4, the semiconductor layer SCL may include a first semiconductor pattern SCL1 and a second semiconductor pattern SCL2.

Referring to FIG. 5, a first conductive layer CL1 may be located on the semiconductor layer SCL (see FIG. 4). The first conductive layer CL1 may include branch gate lines BGL1a, BGL2a, BGL3a, BGL4a, and BGL5a. The first conductive layer CL1 may include a first conductive pattern CLP1 and a second conductive pattern CLP2. The first conductive layer CL1 may include a second initialization line VINTL2.

A portion of the first conductive pattern CLP1 that overlaps the first semiconductor pattern SCL1 (see FIG. 4) may be a gate electrode of the first transistor T1. The first conductive pattern CLP1 may be a first electrode of the capacitor Cst (see FIG. 3).

A portion of the branch gate line BGL2a that overlaps the first semiconductor pattern SCL1 (see FIG. 4) may be a gate electrode of the second transistor T2.

A portion of the second conductive pattern CLP2 that overlaps the first semiconductor pattern SCL1 (see FIG. 4) may be a gate electrode of the third transistor T3. For example, the second conductive pattern CLP2 may overlap the first semiconductor pattern SCL1 (see FIG. 4) twice. That is, a gate electrode of the third transistor T3 may be formed as a dual gate electrode.

A portion of the branch gate line BGL1a that overlaps with the first semiconductor pattern SCL1 (see FIG. 4) may be a gate electrode of the fourth transistor T4. For example, the branch gate line BGL1a may overlap the first semiconductor pattern SCL1 (see FIG. 4) twice. That is, a gate electrode of the fourth transistor T4 may be formed as a dual gate electrode.

A first portion of the branch gate line BGL3a that overlaps with the first semiconductor pattern SCL1 (see FIG. 4) may be a gate electrode of the fifth transistor T5. A second portion of the branch gate line BGL3a that overlaps with the first semiconductor pattern SCL1 (see FIG. 4) may be a gate electrode of the sixth transistor T6. A third portion of the branch gate line BGL3a that overlaps with the first semiconductor pattern SCL1 (see FIG. 4) may be a gate electrode of the eighth transistor T8.

A portion of the branch gate line BGL5a that overlaps with the first semiconductor pattern SCL1 (see FIG. 4) may be a gate electrode of the seventh transistor T7.

A portion of the branch gate line BGL4a that overlaps with the first semiconductor pattern SCL1 (see FIG. 4) may be a gate electrode of the ninth transistor T9.

Referring to FIG. 6, the second conductive layer CL2 may be located on the first conductive layer CL1. The second conductive layer CL2 may include a third conductive pattern CLP3, a first initialization line VINTL1, and a third power line PL3.

The third conductive pattern CLP3 may be a second electrode of the capacitor Cst (see FIG. 3). That is, the first conductive pattern CLP1 (see FIG. 5) and the third conductive pattern CLP3 may form the capacitor Cst (see FIG. 3).

FIG. 7 schematically illustrates a gate line according to some embodiments of the present disclosure.

In FIG. 7, the gate line GL connected to a third pixel PX3 located at the outermost edge of a third display area A3 (see FIG. 1) is schematically shown.

Referring to FIG. 7, the gate line GL may include a first gate line GL1, a second gate line GL2, a third gate line GL3, a fourth gate line GL4, and a fifth gate line GL5. The first to fifth gate lines GL1 to GL5 may extend in a first direction DR1 and may be arranged along a second direction DR2.

The first to fifth gate lines GL1 to GL5 may be cut once in the second direction DR2 during manufacturing. For example, each of the first to fifth gate lines GL1 to GL5 may include a first cut portion CS1. The first cut portion CS1 may be a truncated portion of the first to fifth gate lines GL1 to GL5. In one or more embodiments, the first cut portion CS1 may be adjacent to the third pixel PX3.

The first gate line GL1 may include two branch gate lines BGL1a and BGL1b formed by the first cut portion CS1 (as used herein with respect to the described cut portions, “formed by” may indicate “separated by,” “defined by,” or “defining”). The two branch gate lines BGL1a and BGL1b may be spaced apart and electrically isolated from each other. For example, the two branch gate lines BGL1a and BGL1b may be spaced apart from each other by a first distance d1 in the first direction DR1. The branch gate line BGL1a may be connected to a gate electrode of the fourth transistor T4. The branch gate line BGL1b may be connected to the gate driver 120.

In one or more embodiments, the two branch gate lines BGL1a and BGL1b may be located in the same layer. For example, the two branch gate lines BGL1a and BGL1b may be included in the first conductive layer CL1 (see FIG. 5). However, embodiments are not necessarily limited thereto. For example, the branch gate line BGL1a may be included in the first conductive layer CL1 (see FIG. 5) and the branch gate line BGL1b may be included in the second conductive layer CL2 (see FIG. 6).

The second gate line GL2 may include two branch gate lines BGL2a and BGL2b formed by the first cut portion CS1. The two branch gate lines BGL2a and BGL2b may be spaced apart and electrically isolated from each other. For example, the two branch gate lines BGL2a and BGL2b may be spaced apart from each other by a first distance d1 in the first direction DR1. The branch gate line BGL2a may be connected to a gate electrode of the second transistor T2. The branch gate line BGL2b may be connected to the gate driver 120.

In one or more embodiments, the two branch gate lines BGL2a and BGL2b may be located in different respective layers. For example, the branch gate line BGL2a may be included in the first conductive layer CL1 (see FIG. 5) and the branch gate line BGL2b may be included in the second conductive layer CL2 (see FIG. 6). However, embodiments are not necessarily limited to these. For example, the two branch gate lines BGL2a and BGL2b may be included in the first conductive layer CL1 (see FIG. 5).

The third gate line GL3 may include two branch gate lines BGL3a and BGL3b formed by the first cut portion CS1. The two branch gate lines BGL3a and BGL3b may be spaced apart and electrically isolated from each other. For example, the two branch gate lines BGL3a and BGL3b may be spaced apart from each other by a first distance d1 in the first direction DR1.

In one or more embodiments, the two branch gate lines BGL3a and BGL3b may be arranged in the same layer. For example, the two branch gate lines BGL3a and BGL3b may be included in the first conductive layer CL1 (see FIG. 5). However, embodiments are not necessarily limited thereto. For example, the branch gate line BGL3a may be included in the first conductive layer CL1 (see FIG. 5) and the branch gate line BGL3b may be included in the second conductive layer CL2 (see FIG. 6).

The fourth gate line GL4 may include two branch gate lines BGL4a and BGL4b formed by the first cut portion CS1. The two branch gate lines BGL4a and BGL4b may be spaced apart and electrically isolated from each other. For example, the two branch gate lines BGL4a and BGL4b may be spaced apart from each other by a first distance d1 in the first direction DR1.

In one or more embodiments, the two branch gate lines BGL4a and BGL4b may be arranged in different respective layers. For example, the branch gate line BGL4a may be included in the first conductive layer CL1 (see FIG. 5) and the branch gate line BGL4b may be included in the second conductive layer CL2 (see FIG. 6). However, embodiments are not necessarily limited to these. For example, the two branch gate lines BGL4a and BGL4b may be included in the first conductive layer CL1 (see FIG. 5).

The fifth gate line GL5 may include two branch gate lines BGL5a and BGL5b formed by the first cut portion CS1. The two branch gate lines BGL5a and BGL5b may be spaced apart and electrically isolated from each other. For example, the two branch gate lines BGL5a and BGL5b may be spaced apart from each other by a first distance d1 in the first direction DR1.

In one or more embodiments, the two branch gate lines BGL5a and BGL5b may be arranged in the same layer. For example, the two branch gate lines BGL5a and BGL5b may be included in the first conductive layer CL1 (see FIG. 5). However, embodiments are not necessarily limited thereto. For example, the branch gate line BGL5a may be included in the first conductive layer CL1 (see FIG. 5) and the branch gate line BGL5b may be included in the second conductive layer CL2 (see FIG. 6).

As shown in FIG. 1, the gate line GL connected to the third pixel PX3 may be longer than the gate lines GL connected to the first and second pixels PX1 and PX2. That is, the length and/or area of the first to fifth gate lines GL1 to GL5 connected to the third pixel PX3 may be the greatest. Therefore, the third pixel PX3 may be more susceptible to electrostatic effects. For example, during the manufacturing process, excessive static electricity may be introduced into the branch gate lines BGL1b, BGL2b, BGL3b, BGL4b, and BGL5b that are connected to the gate driver 120. Excessive static electricity may accumulate at the ends of the branch gate lines BGL1b, BGL2b, BGL3b, BGL4b, and BGL5b that connect to the third pixel PX3. The accumulated static electricity may form an electric field that can cause coupling between the branch gate lines BGL1b, BGL2b, BGL3b, BGL4b, and BGL5b and the branch gate lines BGL1a, BGL2a, BGL3a, BGL4a, and BGL5a adjacent to them. Due to the excessive potential rise of the branch gate lines BGL1a, BGL2a, BGL3a, BGL4a, and BGL5a, gate-insulating layers of the transistors of the third pixel PX3 connected to them may be destroyed, and insulation characteristics may be degraded. Damage to the transistors due to deterioration of insulation characteristics may occur in the transistors located at the outermost edge of the third pixel PX3. For example, the second transistor T2, the fourth transistor T4, the seventh transistor T7, the eighth transistor T8, and the ninth transistor T9 of the third pixel PX3 may be damaged.

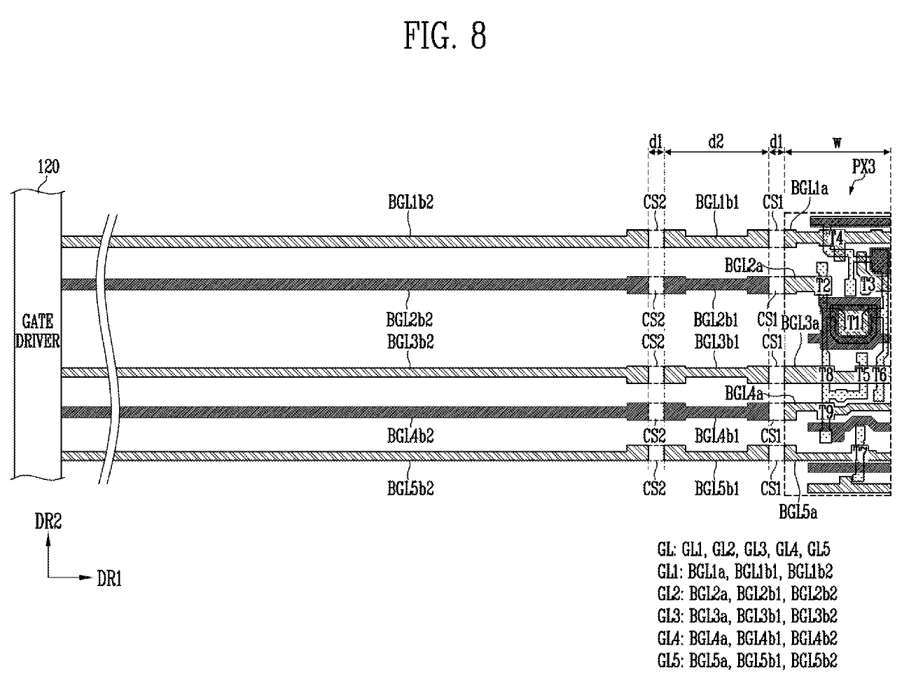

FIGS. 8 - 11 schematically illustrate gate lines according to some embodiments of the present disclosure. In FIGS. 8 - 11, previously described content is briefly explained or omitted.

Referring to FIG. 8, in one or more embodiments, the first to fifth gate lines GL1 to GL5 may be cut twice in the second direction DR2 during the manufacturing process. For example, each of the first to fifth gate lines GL1 to GL5 may include a first cut portion CS1 and a second cut portion CS2. The second cut portion CS2 may be a cut portion of the first to fifth gate lines GL1 to GL5 at a location spaced apart from the first cut portion CS1. The first cut portion CS1 may be further away from the gate driver 120 compared to the second cut portion CS2.

The first gate line GL1 may include three branch gate lines BGL1a, BGL1b1, and BGL1b2 formed by the first cut portion CS1 and the second cut portion CS2. The branch gate lines BGL1b1 and BGL1b2 may be formed by separating the branch gate line BGL1b shown in FIG. 7. The three branch gate lines BGL1a, BGL1b1, and BGL1b2 may be spaced apart and electrically isolated from each other. For example, the three branch gate lines BGL1a, BGL1b1, and BGL1b2 may be spaced apart from each other by a first distance d1 in the first direction DR1. The branch gate line BGL1b2 may be connected to the gate driver 120.

The second gate line GL2 may include three branch gate lines BGL2a, BGL2b1, and BGL2b2 formed by the first cut portion CS1 and the second cut portion CS2. The branch gate lines BGL2b1 and BGL2b2 may be formed by separating the branch gate line BGL2b shown in FIG. 7. The three branch gate lines BGL2a, BGL2b1, and BGL2b2 may be spaced apart and electrically isolated from each other. For example, the three branch gate lines BGL2a, BGL2b1, and BGL2b2 may be spaced apart from each other by a first distance d1 in the first direction DR1. A branch gate line BGL2b2 may be connected to the gate driver 120.

The third gate line GL3 may include three branch gate lines BGL3a, BGL3b1, and BGL3b2 formed by the first cut portion CS1 and the second cut portion CS2. The branch gate lines BGL3b1 and BGL3b2 may be formed by separating the branch gate line BGL3b shown in FIG. 1. The three branch gate lines BGL3a, BGL3b1, and BGL3b2 may be spaced apart and electrically isolated from each other. For example, the three branch gate lines BGL3a, BGL3b1, and BGL3b2 may be spaced apart from each other by a first distance d1 in the first direction DR1. The branch gate line BGL3b2 may be connected to the gate driver 120.

The fourth gate line GL4 may include three branch gate lines BGL4a, BGL4b1, and BGL4b2 formed by the first cut portion CS1 and the second cut portion CS2. The branch gate lines BGL4b1 and BGL4b2 may be formed by separating the branch gate line BGL4b shown in FIG. 7. The three branch gate lines BGL4a, BGL4b1, and BGL4b2 may be spaced apart and electrically isolated from each other. For example, the three branch gate lines BGL4a, BGL4b1, and BGL4b2 may be spaced apart from each other by a first distance d1 in the first direction DR1. The branch gate line BGL4b2 may be connected to the gate driver 120.

The fifth gate line GL5 may include three branch gate lines BGL5a, BGL5b1, and BGL5b2 formed by the first cut portion CS1 and the second cut portion CS2. The branch gate lines BGL5b1 and BGL5b2 may be formed by separating the branch gate line BGL5b shown in FIG. 7. The three branch gate lines BGL5a, BGL5b1, and BGL5b2 may be spaced apart and electrically isolated from each other. For example, the three branch gate lines BGL5a, BGL5b1, and BGL5b2 may be spaced apart from each other by a first distance d1 in the first direction DR1. The branch gate line BGL5b2 may be connected to the gate driver 120.

The second cut portion CS2 may be spaced apart from the first cut portion CS1 in the first direction DR1. For example, the first and second cut portions CS1 and CS2 may be spaced apart from each other in the first direction DR1 by a second distance d2. The second distance d2 may correspond to, or may be substantially equal to, a size of the third pixel PX3 (as used herein, “a size of” may mean “a dimension of,” such as “a width of”). For example, the second distance d2 may be equal to a width w in the first direction DR1 of the third pixel PX3. However, embodiments are not necessarily limited thereto. For example, the second distance d2 may be larger than the width w in the first direction DR1 of the third pixel PX3.

As each of the first to fifth gate lines GL1 to GL5 further includes the second cut portion CS2, the area of the first to fifth gate lines GL1 to GL5 may decrease. Therefore, the amount of electrostatic charge that flows into and accumulates on the branch gate lines BGL1b2, BGL2b2, BGL3b2, BGL4b2, and BGL5b2 connected to the gate driver 120 may be reduced.

The first distance d1 may be from about 5μm to about 15μm. When the first distance d1 meets the above range, the amount of electrostatic charge induced into the neighboring branch gate lines by the coupling may be reduced. For example, as the first distance d1 increases, the amount of electrostatic charge induced on the branch gate lines BGL1b1, BGL2b1, BGL3b1, BGL4b1, BGL5b1 may decrease. As coupling is cascaded suppressed, the amount of electrostatic charge induced on the branch gate lines BGL1a, BGL2a, BGL3a, BGL4a, and BGL5a may be reduced. As a result, damage to the transistors located on the outermost edge of the third pixel PX3 may be avoided during the manufacturing process.

Experimentally, the strength of the electric field measured on the transistors located at the outermost edge of the third pixel PX3 of FIG. 8 was reduced. For example, the strength of the electric field measured at the second transistor T2 is reduced by about 49.1% in FIG. 8 compared to FIG. 7. For example, the strength of the electric field measured at the fourth transistor T4 is reduced by about 41.2% in FIG. 8 compared to FIG. 7. For example, the strength of the electric field measured at the seventh transistor T7 is reduced by about 31.0% in FIG. 8 compared to FIG. 7. For example, the strength of the electric field measured at the eighth transistor T8 is reduced by about 44.8% in FIG. 8 compared to FIG. 7. For example, the strength of the electric field measured at the ninth transistor T9 is reduced by about 42.6% in FIG. 8 compared to FIG. 7.

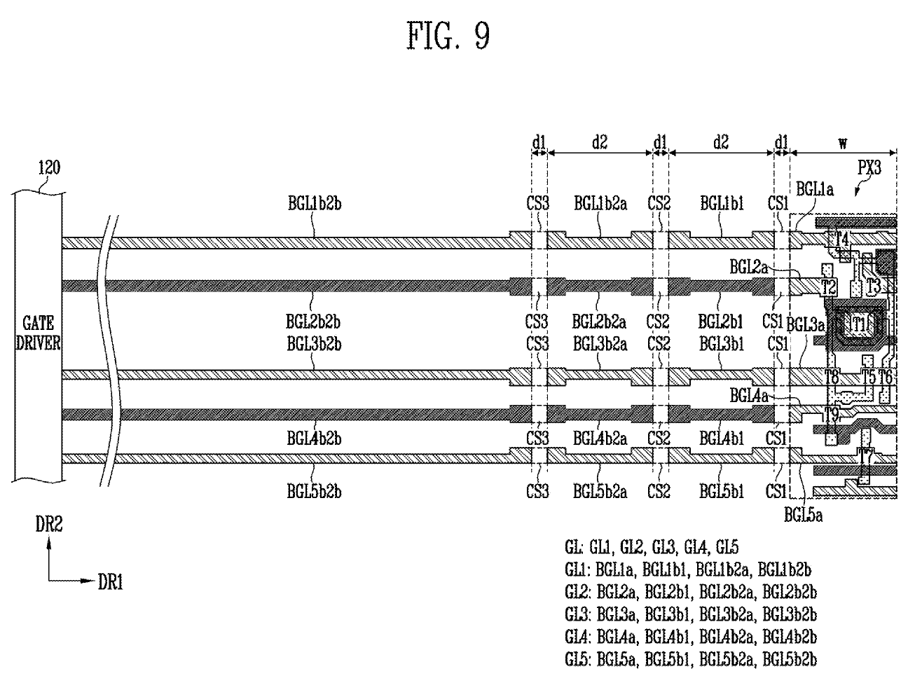

Referring to FIG. 9, in one or more embodiments, the first to fifth gate lines GL1 to GL5 may be cut three times in the second direction DR2 during the manufacturing process. For example, each of the first to fifth gate lines GL1 to GL5 may include a first cut portion CS1, a second cut portion CS2, and a third cut portion CS3. The third cut portion CS3 may be a cut portion of the first to fifth gate lines GL1 to GL5 at a position spaced apart from the second cut portion CS2. The first cut portion CS1 may be farther away from the gate driver 120 than the second and third cut portions CS2 and CS3.

The first gate line GL1 may include four branch gate lines BGL1a, BGL1b1, BGL1b2a, and BGL1b2b formed by the first to third cut portions CS1 to CS3. The branch gate lines BGL1b2a and BGL1b2b may be formed by separating the branch gate line BGL1b2 shown in FIG. 8. The four branch gate lines BGL1a, BGL1b1, BGL1b2a, and BGL1b2b may be spaced apart and electrically isolated from each other. For example, the four branch gate lines BGL1a, BGL1b1, BGL1b2a, and BGL1b2b may be spaced apart from each other by a first distance d1 in the first direction DR1. The branch gate line BGL1b2b may be connected to the gate driver 120.

The second gate line GL2 may include four branch gate lines BGL2a, BGL2b1, BGL2b2a, and BGL2b2b formed by the first to third cut portions CS1 to CS3. The branch gate lines BGL2b2a and BGL2b2b may be formed by separating the branch gate line BGL2b2 shown in FIG. 8. The four branch gate lines BGL2a, BGL2b1, BGL2b2a, and BGL2b2b may be spaced apart and electrically isolated from each other. For example, the four branch gate lines BGL2a, BGL2b1, BGL2b2a, and BGL2b2b may be spaced apart from each other by a first distance d1 in the first direction DR1. The branch gate line BGL2b2b may be connected to the gate driver 120.

The third gate line GL3 may include four branch gate lines BGL3a, BGL3b1, BGL3b2a, and BGL3b2b formed by the first to third cut portions CS1 to CS3. The branch gate lines BGL3b2a and BGL3b2b may be formed by separating the branch gate line BGL3b2 shown in FIG. 8. The four branch gate lines BGL3a, BGL3b1, BGL3b2a, and BGL3b2b may be spaced apart and electrically isolated from each other. For example, the four branch gate lines BGL3a, BGL3b1, BGL3b2a, and BGL3b2b may be spaced apart from each other by a first distance d1 in the first direction DR1. The branch gate line BGL3b2b may be connected to the gate driver 120.

The fourth gate line GL4 may include four branch gate lines BGL4a, BGL4b1, BGL4b2a, and BGL4b2b formed by the first to third cut portions CS1 to CS3. The branch gate lines BGL4b2a and BGL4b2b may be formed by separating the branch gate line BGL4b2 shown in FIG. 8. The four branch gate lines BGL4a, BGL4b1, BGL4b2a, and BGL4b2b may be spaced apart and electrically isolated from each other. For example, the four branch gate lines BGL4a, BGL4b1, BGL4b2a, and BGL4b2b may be spaced apart from each other by a first distance d1 in the first direction DR1. The branch gate line BGL4b2b may be connected to the gate driver 120.

The fifth gate line GL5 may include four branch gate lines BGL5a, BGL5b1, BGL5b2a, and BGL5b2b formed by the first to third cut portions CS1 to CS3. The branch gate lines BGL5b2a and BGL5b2b may be formed by separating the branch gate line BGL5b2 shown in FIG. 8. The four branch gate lines BGL5a, BGL5b1, BGL5b2a, and BGL5b2b may be spaced apart and electrically isolated from each other. For example, the four branch gate lines BGL5a, BGL5b1, BGL5b2a, and BGL5b2b may be spaced apart from each other by a first distance d1 in the first direction DR1. The branch gate line BGL5b2b may be connected to the gate driver 120.

The third cut portion CS3 may be spaced apart from the second cut portion CS2 in the first direction DR1. For example, the second and third cut portions CS2 and CS3 may be spaced apart from each other in the first direction DR1 by a second distance d2.

As each of the first to fifth gate lines GL1 to GL5 further includes the third cut portion CS3, the area of the first to fifth gate lines GL1 to GL5 may be further reduced. Therefore, the amount of static electricity that enters and accumulates on the branch gate lines BGL1b2b, BGL2b2b, BGL3b2b, BGL4b2b, and BGL5b2b connected to the gate driver 120 may be further reduced. In addition, the amount of static induced on the branch gate lines BGL1a, BGL2a, BGL3a, BGL4a, and BGL5a may be further reduced as coupling is more suppressed. As a result, damage to the transistors located on the outermost edge of the third pixel PX3 during the manufacturing process may be further reduced or prevented.

Experimentally, the strength of the electric field measured across the transistors located at the outermost edge of the third pixel PX3 of FIG. 9 was further reduced. For example, the strength of the electric field measured at the second transistor T2 is reduced by about 65.8% in FIG. 9 compared to FIG. 7. For example, the strength of the electric field measured at the fourth transistor T4 is reduced by about 57.4% in FIG. 9 compared to FIG. 7. For example, the strength of the electric field measured at the seventh transistor T7 is reduced by about 46.3% in FIG. 9 compared to FIG. 7. For example, the electric field strength measured at the eighth transistor T8 is reduced by about 60.9% in FIG. 9 compared to FIG. 7. For example, the strength of the electric field measured at the ninth transistor T9 is reduced by about 58.6% in FIG. 9 compared to FIG. 7.

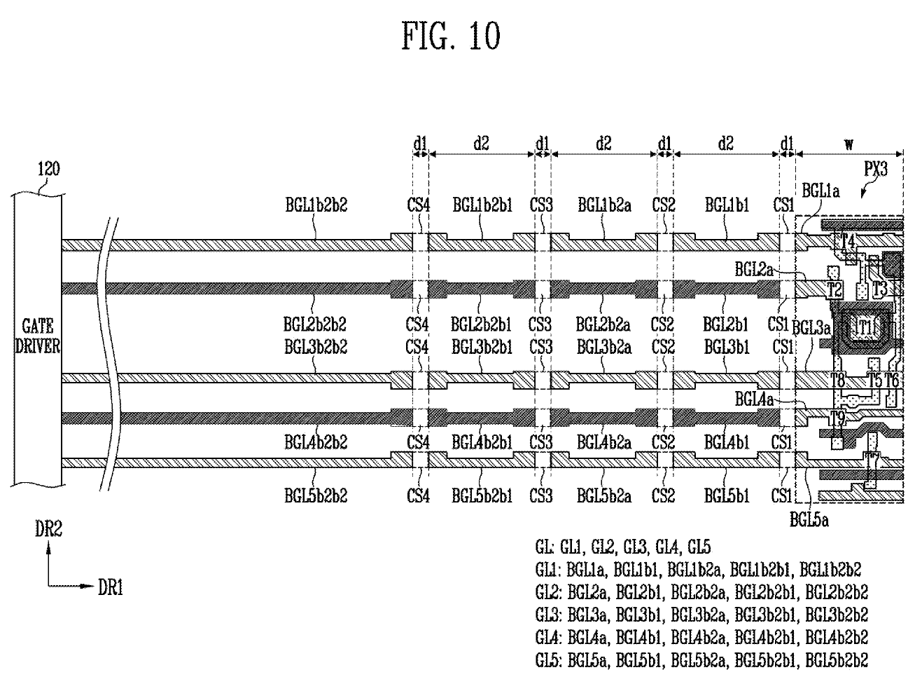

Referring to FIG. 10, in one or more embodiments, the first to fifth gate lines GL1 to GL5 may be cut four times in the second direction DR2 during the manufacturing process. For example, each of the first to fifth gate lines GL1 to GL5 may include a first cut portion CS1, a second cut portion CS2, a third cut portion CS3, and a fourth cut portion CS4. The fourth cut portion CS4 may be a truncated portion of the first to fifth gate lines GL1 to GL5 at a position spaced apart from the third cut portion CS3. The first cut portion CS1 may be further away from the gate driver 120 than the second to fourth cut portions CS2 to CS4.

The first gate line GL1 may include five branch gate lines BGL1a, BGL1b1, BGL1b2a, BGL1b2b1, BGL1b2b1, and BGL1b2b2 formed by the first to fourth cut portions CS1 to CS4. The branch gate lines BGL1b2b1 and BGL1b2b2 may be formed by separating the branch gate line BGL1b2b shown in FIG. 9. The five branch gate lines BGL1a, BGL1b1, BGL1b2a, BGL1b2b1, and BGL1b2b2 may be spaced apart and electrically isolated from each other. For example, the five branch gate lines BGL1a, BGL1b1, BGL1b2a, BGL1b2b1, BGL1b2b1, and BGL1b2b2 may be spaced apart from each other by a first distance d1 in the first direction DR1. The branch gate lines BGL1b2b2 may be connected to the gate driver 120.

The second gate line GL2 may include five branch gate lines BGL2a, BGL2b1, BGL2b2a, BGL2b2b1, BGL2b2b1, and BGL2b2b2 formed by the first to fourth cut portions CS1 to CS4. The branch gate lines BGL2b2b1 and BGL2b2b2 may be formed by separating the branch gate line BGL2b2b shown in FIG. 9. The five branch gate lines BGL2a, BGL2b1, BGL2b2a, BGL2b2b1, and BGL2b2b2 may be spaced apart and electrically isolated from each other. For example, the five branch gate lines BGL2a, BGL2b1, BGL2b2a, BGL2b2b1, BGL2b2b1, and BGL2b2b2 may be spaced apart from each other by a first distance d1 in the first direction DR1. The branch gate line BGL2b2b2 may be connected to the gate driver 120.

The third gate line GL3 may include five branch gate lines BGL3a, BGL3b1, BGL3b2a, BGL3b2b1, BGL3b2b1, and BGL3b2b2 formed by the first to fourth cut portions CS1 to CS4. The branch gate lines BGL3b2b1, BGL3b2b2 may be formed by separating the branch gate line BGL3b2b shown in FIG. 9. The five branch gate lines BGL3a, BGL3b1, BGL3b2a, BGL3b2b1, BGL3b2b2 may be spaced apart and electrically isolated from each other. For example, the five branch gate lines BGL3a, BGL3b1, BGL3b2a, BGL3b2b1, BGL3b2b1, BGL3b2b2 may be spaced apart from each other by a first distance d1 in the first direction DR1. The branch gate line BGL3b2b2 may be connected to the gate driver 120.

The fourth gate line GL4 may include five branch gate lines BGL4a, BGL4b1, BGL4b2a, BGL4b2b1, BGL4b2b1, and BGL4b2b2 formed by the first to fourth cut portions CS1 to CS4. The branch gate lines BGL4b2b1 and BGL4b2b2 may be formed by separating the branch gate line BGL4b2b shown in FIG. 9. The five branch gate lines BGL4a, BGL4b1, BGL4b2a, BGL4b2b1, and BGL4b2b2 may be spaced apart and electrically isolated from each other. For example, the five branch gate lines BGL4a, BGL4b1, BGL4b2a, BGL4b2b1, BGL4b2b1, and BGL4b2b2 may be spaced apart from each other by a first distance d1 in the first direction DR1. The branch gate line BGL4b2b2 may be connected to the gate driver 120.

The fifth gate line GL5 may include five branch gate lines BGL5a, BGL5b1, BGL5b2a, BGL5b2b1, BGL5b2b1, and BGL5b2b2 formed by the first to fourth cut portions CS1 to CS4. The branch gate lines BGL5b2b1 and BGL5b2b2 may be formed by separating the branch gate line BGL5b2b shown in FIG. 9. The five branch gate lines BGL5a, BGL5b1, BGL5b2a, BGL5b2b1, and BGL5b2b2 may be spaced apart and electrically isolated from each other. For example, the five branch gate lines BGL5a, BGL5b1, BGL5b2a, BGL5b2b1, BGL5b2b1, and BGL5b2b2 may be spaced apart from each other by a first distance d1 in the first direction DR1. The branch gate lines BGL5b2b2 may be connected to the gate driver 120.

The fourth cut portion CS4 may be spaced apart from the third cut portion CS3 in the first direction DR1. For example, the third and fourth cut portions CS3 and CS4 may be spaced apart from each other in the first direction DR1 by a second distance d2.

As the first to fifth gate lines GL1 to GL5 each include a fourth cut portion CS4, the area of the first to fifth gate lines GL1 to GL5 may be further reduced. Accordingly, the amount of static electricity that enters and accumulates on the branch gate lines BGL1b2b2, BGL2b2b2, BGL3b2b2, BGL4b2b2, and BGL5b2b2 connected to the gate driver 120 may be further reduced. Furthermore, as coupling is further suppressed, the amount of static induced on the branch gate lines BGL1a, BGL2a, BGL3a, BGL4a, and BGL5a may be further reduced. As a result, damage to the transistors located on the outermost edge of the third pixel PX3 during the manufacturing process may be further reduced or prevented.

Experimentally, the strength of the electric field measured on the transistors located at the outermost edge of the third pixel PX3 of FIG. 10 was further reduced. For example, the strength of the electric field measured at the second transistor T2 is reduced by about 75.5% in FIG. 10 compared to FIG. 7. For example, the strength of the electric field measured at the fourth transistor T4 is reduced by about 67.7% in FIG. 10 compared to FIG. 7. For example, the strength of the electric field measured at the seventh transistor T7 is reduced by about 56.9% in FIG. 10 compared to FIG. 7. For example, the strength of the electric field measured at the eighth transistor T8 is reduced by about 71.0% in FIG. 10 compared to FIG. 7. For example, the strength of the electric field measured at the ninth transistor T9 is reduced by about 69.0% in FIG. 10 compared to FIG. 7.

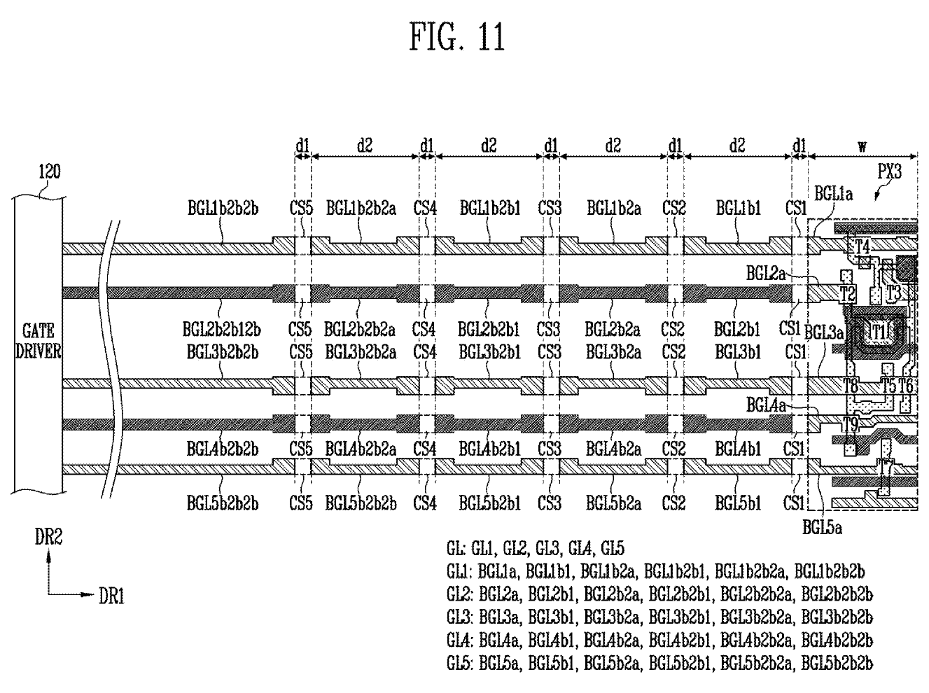

Referring to FIG. 11, in one or more embodiments, the first to fifth gate lines GL1 to GL5 may be cut five times in the second direction DR2 during the manufacturing process. For example, each of the first to fifth gate lines GL1 to GL5 may include a first cut portion CS1, a second cut portion CS2, a third cut portion CS3, a fourth cut portion CS4, and a fifth cut portion CS5. The fifth cut portion CS5 may be a cut portion of the first to fifth gate lines GL1 to GL5 at a location spaced apart from the fourth cut portion CS4. The first cut portion CS1 may be further away from the gate driver 120 than the second to fifth cut portions CS2 to CS5.

The first gate line GL1 may include six branch gate lines BGL1a, BGL1b1, BGL1b2a, BGL1b2b1, BGL1b2b2a, BGL1b2b2a, BGL1b2b2b, and BGL1b2b2b formed by the first to fifth cut portions CS1 to CS5. The branch gate lines BGL1b2b2a and BGL1b2b2b may be formed by separating the branch gate line BGL1b2b2 shown in FIG. 10. The six branch gate lines BGL1a, BGL1b1, BGL1b2a, BGL1b2b1, BGL1b2b2a, and BGL1b2b2b may be spaced apart and electrically isolated from each other. For example, the six branch gate lines BGL1a, BGL1b1, BGL1b2a, BGL1b2b1, BGL1b2b2a, BGL1b2b2a, and BGL1b2b2b may be spaced apart from each other by a first distance d1 in the first direction DR1. The branch gate line BGL1b2b2b may be connected to the gate driver 120.

The second gate line GL2 may include six branch gate lines BGL2a, BGL2b1, BGL2b2a, BGL2b2b1, BGL2b2b2a, BGL2b2b2a, BGL2b2b2b, and BGL2b2b2b, formed by the first to fifth cut portions CS1 to CS5. The branch gate lines BGL2b2b2a and BGL2b2b2b may be formed by separating the branch gate line BGL2b2b2 shown in FIG. 10. The six branch gate lines BGL2a, BGL2b1, BGL2b2a, BGL2b2b1, BGL2b2b2a, BGL2b2b2b, and BGL2b2b2b may be spaced apart and electrically isolated from each other. For example, the six branch gate lines BGL2a, BGL2b1, BGL2b2a, BGL2b2b1, BGL2b2b2a, BGL2b2b2b, and BGL2b2b2b may be spaced apart from each other by a first distance d1 in the first direction DR1. The branch gate line BGL2b2b2b may be connected to the gate driver 120.

The third gate line GL3 may include six branch gate lines BGL3a, BGL3b1, BGL3b2a, BGL3b2b1, BGL3b2b2a, BGL3b2b2a, BGL3b2b2b, and BGL3b2b2b, formed by the first to fifth cut portions CS1 to CS5. The branch gate lines BGL3b2b2a and BGL3b2b2b may be formed by separating the branch gate line BGL3b2b2 shown in FIG. 10. The six branch gate lines BGL3a, BGL3b1, BGL3b2a, BGL3b2b1, BGL3b2b2a, BGL3b2b2a, and BGL3b2b2b may be spaced apart and electrically isolated from each other. For example, the six branch gate lines BGL3a, BGL3b1, BGL3b2a, BGL3b2b1, BGL3b2b2a, BGL3b2b2b, and BGL3b2b2b may be spaced apart from each other by a first distance d1 in the first direction DR1. The branch gate line BGL3b2b2b may be connected to the gate driver 120.

The fourth gate line GL4 may include six branch gate lines BGL4a, BGL4b1, BGL4b2a, BGL4b2b1, BGL4b2b2a, BGL4b2b2a, BGL4b2b2b, and BGL4b2b2b formed by the first to fifth cut portions CS1 to CS5. The branch gate lines BGL4b2b2a and BGL4b2b2b may be formed by separating the branch gate line BGL4b2b2 shown in FIG. 10. The six branch gate lines BGL4a, BGL4b1, BGL4b2a, BGL4b2b1, BGL4b2b2a, BGL4b2b2b, and BGL4b2b2b may be spaced apart and electrically isolated from each other. For example, the six branch gate lines BGL4a, BGL4b1, BGL4b2a, BGL4b2b1, BGL4b2b2a, BGL4b2b2b, and BGL4b2b2b may be spaced apart from each other by a first distance d1 in the first direction DR1. The branch gate line BGL4b2b2b may be connected to the gate driver 120.

The fifth gate line GL5 may include six branch gate lines BGL5a, BGL5b1, BGL5b2a, BGL5b2b1, BGL5b2b2a, BGL5b2b2a, and BGL5b2b2b formed by the first to fifth cut portions CS1 to CS5. The branch gate lines BGL5b2b2a and BGL5b2b2b may be formed by separating the branch gate line BGL5b2b2 shown in FIG. 10. The six branch gate lines BGL5a, BGL5b1, BGL5b2a, BGL5b2b1, BGL5b2b2a, BGL5b2b2b and BGL5b2b2b may be spaced apart and electrically isolated from each other. For example, the six branch gate lines BGL5a, BGL5b1, BGL5b2a, BGL5b2b1, BGL5b2b2a, BGL5b2b2b, and BGL5b2b2b may be spaced apart from each other by a first distance d1 in the first direction DR1. The branch gate lines BGL5b2b2b may be connected to the gate driver 120.

The fifth cut portion CS5 may be spaced apart from the fourth cut portion CS4 in the first direction DR1. For example, the fourth and fifth cut portions CS4 and CS5 may be spaced apart from each other in the first direction DR1 by a second distance d2.

As each of the first to fifth gate lines GL1 to GL5 further includes the fifth cut portion CS5, the area of the first to fifth gate lines GL1 to GL5 may further decrease. Thus, the amount of electrostatic charge that enters and accumulates on the branch gate lines BGL1b2b2b, BGL2b2b2b, BGL3b2b2b, BGL4b2b2b, and BGL5b2b2b connected to the gate driver 120 may be further reduced. Furthermore, as coupling is further suppressed, the amount of electrostatic charge induced on the branch gate lines BGL1a, BGL2a, BGL3a, BGL4a, and BGL5a may be further reduced. As a result, damage to the transistors located on the outermost edge of the third pixel PX3 may be further reduced or prevented during the manufacturing process.

Experimentally, the strength of the electric field measured across the transistors located at the outermost edge of the third pixel PX3 of FIG. 11 was further reduced. For example, the strength of the electric field measured at the second transistor T2 is reduced by about 80.6% in FIG. 11 compared to FIG. 7. For example, the strength of the electric field measured at the fourth transistor T4 is reduced by about 73.6% in FIG. 11 compared to FIG. 7. For example, the strength of the electric field measured at the seventh transistor T7 is reduced by about 64.0% in FIG. 11 compared to FIG. 7. For example, the electric field strength measured at the eighth transistor T8 is reduced by about 76.4% in FIG. 11 compared to FIG. 7. For example, the strength of the electric field measured at the ninth transistor T9 is reduced by about 74.6% in FIG. 11 compared to FIG. 7.

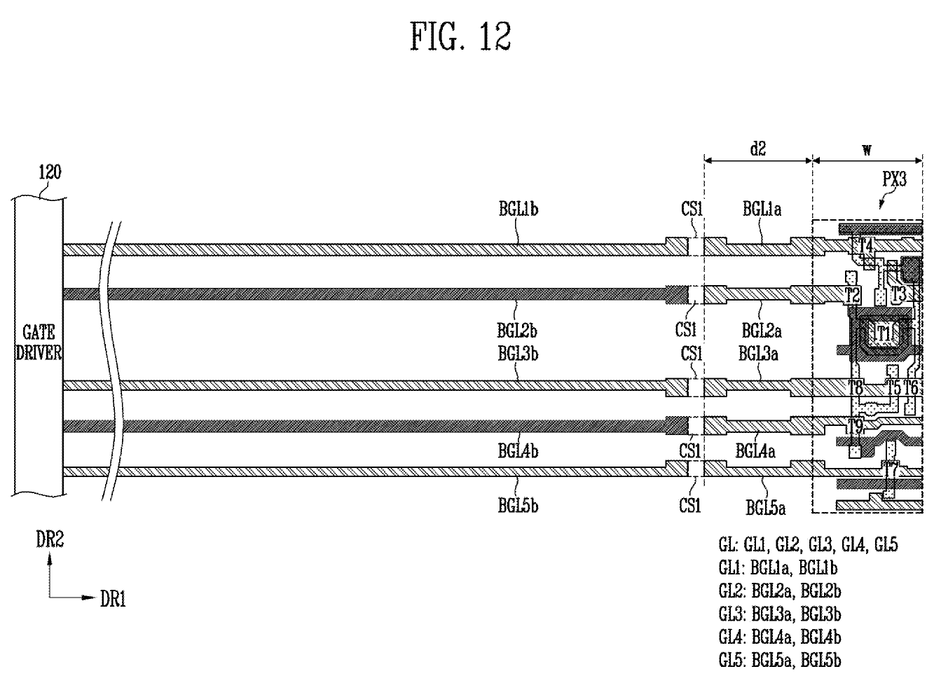

FIGS. 12 - 15 schematically illustrate gate lines according to some embodiments of the present disclosure. In FIGS. 12 - 15, previously described content is briefly explained or omitted.

Referring to FIG. 12, the first cut portion CS1 of the first gate line GL1 may be spaced apart from the third pixel PX3 by a second distance d2 in the first direction DR1. For example, the first cut portion CS1 of the first gate line GL1 may be spaced apart from the third pixel PX3 by a size or width of the third pixel PX3 in the first direction DR1. For example, the first cut portion CS1 of the first gate line GL1 may be spaced apart from the third pixel PX3 in the first direction DR1 by a width w of the third pixel PX3 in the first direction DR1. In other words, the branch gate line BGL1a may extend by a second distance d2 toward the gate driver 120 in FIG. 12 compared to FIG. 7. As a region where the coupling occurs is farther away from the third pixel PX3, the effect of the electric field caused by the electrostatic charge accumulated in the branch gate line BGL1b on the fourth transistor T4 may decrease. Experimentally, the strength of the electric field measured at the fourth transistor T4 is reduced by about 53.0% in FIG. 12 compared to FIG. 7.

The first cut portion CS1 of the second gate line GL2 may be spaced apart from the third pixel PX3 by a second distance d2 in the first direction DR1. For example, the first cut portion CS1 of the second gate line GL2 may be spaced apart from the third pixel PX3 by a size or width of the third pixel PX3 in the first direction DR1. For example, the first cut portion CS1 of the second gate line GL2 may be spaced apart from the third pixel PX3 in the first direction DR1 by a width w of the third pixel PX3 in the first direction DR1. In other words, the branch gate line BGL2a may extend by a second distance d2 toward the gate driver 120 in FIG. 12 compared to FIG. 7. As a region where the coupling occurs is further away from the third pixel PX3, the effect of the electric field caused by the electrostatic charge accumulated on the branch gate line BGL2b on the second transistor T2 may decrease. Experimentally, the strength of the electric field measured at the second transistor T2 is reduced by about 21.4% in FIG. 12 compared to FIG. 7.

The first cut portion CS1 of the third gate line GL3 may be spaced apart from the third pixel PX3 by a second distance d2 in the first direction DR1. For example, the first cut portion CS1 of the third gate line GL3 may be spaced apart from the third pixel PX3 by a size or width of the third pixel PX3 in the first direction DR1. For example, the first cut portion CS1 of the third gate line GL3 may be spaced apart from the third pixel PX3 in the first direction DR1 by a width w of the third pixel PX3 in the first direction DR1. In other words, the branch gate line BGL3a may extend by a second distance d2 toward the gate driver 120 in FIG. 12 compared to FIG. 7. As a region where the coupling occurs is farther away from the third pixel PX3, the effect of the electric field caused by the electrostatic charge accumulated in the branch gate line BGL3b on the eighth transistor T8 may decrease. Experimentally, the strength of the electric field measured at the eighth transistor T8 is reduced by about 71.1% in FIG. 12 compared to FIG. 7.

The first cut portion CS1 of the fourth gate line GL4 may be spaced apart from the third pixel PX3 by a second distance d2 in the first direction DR1. For example, the first cut portion CS1 of the fourth gate line GL4 may be spaced apart from the third pixel PX3 by a size or width of the third pixel PX3 in the first direction DR1. For example, the first cut portion CS1 of the fourth gate line GL4 may be spaced apart from the third pixel PX3 in the first direction DR1 by width w of the third pixel PX3 in the first direction DR1. Inother words, the branch gate line BGL4a may extend by a second distance d2 toward the gate driver 120 in FIG. 12 compared to FIG. 7. As a region where the coupling occurs is farther away from the third pixel PX3, the effect of the electric field caused by the electrostatic charge accumulated in the branch gate line BGL4b on the ninth transistor T9 may decrease. Experimentally, the intensity of the electric field measured at the ninth transistor T9 is reduced by about 77.0% in FIG. 12 compared to FIG. 7.

The first cut portion CS1 of the fifth gate line GL5 may be spaced apart from the third pixel PX3 by a second distance d2 in the first direction DR1. For example, the first cut portion CS1 of the fifth gate line GL5 may be spaced apart from the third pixel PX3 by a size or width of the third pixel PX3 in the first direction DR1. For example, the first cut portion CS1 of the fifth gate line GL5 may be spaced apart from the third pixel PX3 in the first direction DR1 by a width w of the third pixel PX3 in the first direction DR1. In other words, the branch gate line BGL5a may extend by a second distance d2 toward the gate driver 120 in FIG. 12 compared to FIG. 7. As a region where the coupling occurs is further away from the third pixel PX3, the effect of the electric field caused by the electrostatic charge accumulated in the branch gate line BGL5b on the seventh transistor T7 may decrease. Experimentally, the intensity of the electric field measured at the seventh transistor T7 is reduced by about 22.3% in FIG. 12 compared to FIG. 7.

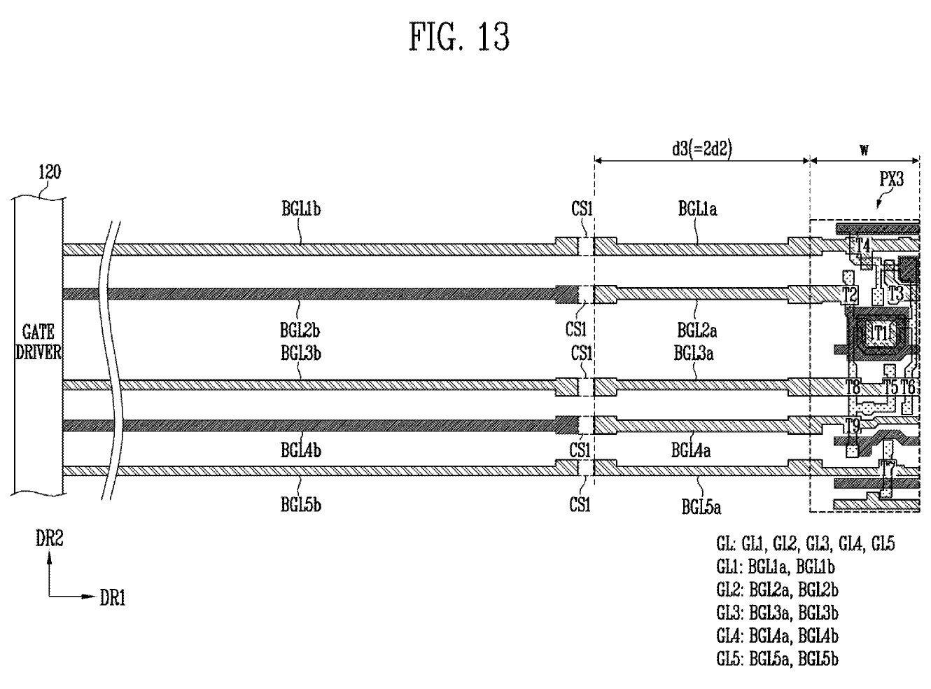

Referring to FIG. 13, the first cut portion CS1 of the first gate line GL1 may be spaced apart from the third pixel PX3 by a third distance d3 in the first direction DR1. The third distance d3 may be about twice the second distance d2 (d3=2d2). For example, the first cut portion CS1 of the first gate line GL1 may be spaced apart from the third pixel PX3 by twice the size or width of the third pixel PX3 in the first direction DR1. For example, the first cut portion CS1 of the first gate line GL1 may be spaced apart from the third pixel PX3 in the first direction DR1 by twice the width w of the third pixel PX3 in the first direction DR1. In other words, the branch gate line BGL1a may extend by a third distance d3 toward the gate driver 120 in FIG. 13 compared to FIG. 7. As a region where the coupling occurs is further away from the third pixel PX3, the effect of the electric field caused by the electrostatic charge accumulated in the branch gate line BGL1b on the fourth transistor T4 may be further reduced. Experimentally, the strength of the electric field measured at the fourth transistor T4 is reduced by about 61.0% in FIG. 13 compared to FIG. 7.

The first cut portion CS1 of the second gate line GL2 may be spaced apart from the third pixel PX3 by a third distance d3 in the first direction DR1. For example, the first cut portion CS1 of the second gate line GL2 may be spaced from the third pixel PX3 by twice the size or width of the third pixel PX3 in the first direction DR1. For example, the first cut portion CS1 of the second gate line GL2 may be spaced apart from the third pixel PX3 in the first direction DR1 by twice the width w of the third pixel PX3 in the first direction DR1. In other words, the branch gate line BGL2a may extend by a third distance d3 toward the gate driver 120 in FIG. 13 compared to FIG. 7. As a region where the coupling occurs is further away from the third pixel PX3, the effect of the electric field caused by the electrostatic charge accumulated in the branch gate line BGL2b on the second transistor T2 may be further reduced. Experimentally, the intensity of the electric field measured at the second transistor T2 is reduced by about 44.9% in FIG. 13 compared to FIG. 7.

The first cut portion CS1 of the third gate line GL3 may be spaced apart from the third pixel PX3 by a third distance d3 in the first direction DR1. For example, the first cut portion CS1 of the third gate line GL3 may be spaced from the third pixel PX3 by twice the size or width of the third pixel PX3 in the first direction DR1. For example, the first cut portion CS1 of the third gate line GL3 may be spaced apart from the third pixel PX3 in the first direction DR1 by twice the width w of the third pixel PX3 in the first direction DR1. In other words, the branch gate line BGL3a may extend by a third distance d3 toward the gate driver 120 in FIG. 13 compared to FIG. 7. As a region where the coupling occurs is further away from the third pixel PX3, the effect of the electric field caused by the electrostatic charge accumulated in the branch gate line BGL3b on the eighth transistor T8 may be further reduced. Experimentally, the intensity of the electric field measured at the eighth transistor T8 is reduced by about 78.7% in FIG. 13 compared to FIG. 7.

The first cut portion CS1 of the fourth gate line GL4 may be spaced apart from the third pixel PX3 by a third distance d3 in the first direction DR1. For example, the first cut portion CS1 of the fourth gate line GL4 may be spaced from the third pixel PX3 by twice the size or width of the third pixel PX3 in the first direction DR1. For example, the first cut portion CS1 of the fourth gate line GL4 may be spaced apart from the third pixel PX3 in the first direction DR1 by twice the width w of the third pixel PX3 in the first direction DR1. In other words, the branch gate line BGL4a may extend by a third distance d3 toward the gate driver 120 in FIG. 13 compared to FIG. 7. As a region where the coupling occurs is further away from the third pixel PX3, the effect of the electric field caused by the electrostatic charge accumulated in the branch gate line BGL4b on the ninth transistor T9 may be further reduced. Experimentally, the strength of the electric field measured at the ninth transistor T9 is reduced by about 81.6% in FIG. 13 compared to FIG. 7.

The first cut portion CS1 of the fifth gate line GL5 may be spaced apart from the third pixel PX3 by a third distance d3 in the first direction DR1. For example, the first cut portion CS1 of the fifth gate line GL5 may be spaced from the third pixel PX3 by twice the size or width of the third pixel PX3 in the first direction DR1. For example, the first cut portion CS1 of the fifth gate line GL5 may be spaced apart from the third pixel PX3 in the first direction DR1 by twice the width w of the third pixel PX3 in the first direction DR1. In other words, the branch gate line BGL5a may extend by a third distance d3 toward the gate driver 120 in FIG. 13 compared to FIG. 7. As a region where the coupling occurs is further away from the third pixel PX3, the effect of the electric field caused by the electrostatic charge accumulated in the branch gate line BGL5b on the seventh transistor T7 may be further reduced. Experimentally, the intensity of the electric field measured at the seventh transistor T7 is reduced by about 29.5% in FIG. 13 compared to FIG. 7.

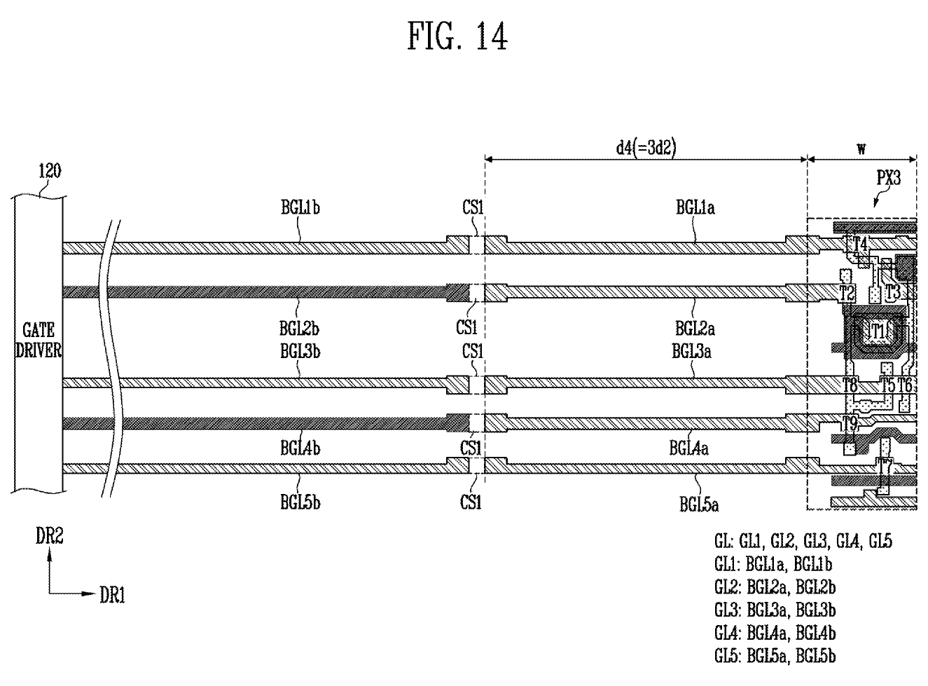

Referring to FIG. 14, the first cut portion CS1 of the first gate line GL1 may be spaced apart from the third pixel PX3 by a fourth distance d4 in the first direction DR1. The fourth distance d4 may be three times the second distance d2 (d4=3d2). For example, the first cut portion CS1 of the first gate line GL1 may be spaced from the third pixel PX3 by three times the size or width of the third pixel PX3 in the first direction DR1. For example, the first cut portion CS1 of the first gate line GL1 may be spaced apart from the third pixel PX3 in the first direction DR1 by three times the width w of the third pixel PX3 in the first direction DR1. In other words, the branch gate line BGL1a may extend by a fourth distance d4 toward the gate driver 120 in FIG. 14 compared to FIG. 7. As a region where the coupling occurs is further away from the third pixel PX3, the effect of the electric field caused by the electrostatic charge accumulated in the branch gate line BGL1b on the fourth transistor T4 may be further reduced. Experimentally, the strength of the electric field measured at the fourth transistor T4 is reduced by about 67.5% in FIG. 14 compared to FIG. 7.

The first cut portion CS1 of the second gate line GL2 may be spaced apart from the third pixel PX3 by a fourth distance d4 in the first direction DR1. For example, the first cut portion CS1 of the second gate line GL2 may be spaced from the third pixel PX3 by three times the size or width of the third pixel PX3 in the first direction DR1. For example, the first cut portion CS1 of the second gate line GL2 may be spaced apart from the third pixel PX3 in the first direction DR1 by three times the width w of the third pixel PX3 in the first direction DR1. In other words, the branch gate line BGL2a may extend by a fourth distance d4 toward the gate driver 120 in FIG. 14 compared to FIG. 7. As a region where the coupling occurs is further away from the third pixel PX3, the effect of the electric field caused by the electrostatic charge accumulated in the branch gate line BGL2b on the second transistor T2 may be further reduced. Experimentally, the intensity of the electric field measured at the second transistor T2 is reduced by about 60.4% in FIG. 14 compared to FIG. 7.

The first cut portion CS1 of the third gate line GL3 may be spaced apart from the third pixel PX3 by a fourth distance d4 in the first direction DR1. For example, the first cut portion CS1 of the third gate line GL3 may be spaced from the third pixel PX3 by three times the size or width of the third pixel PX3 in the first direction DR1. For example, the first cut portion CS1 of the third gate line GL3 may be spaced apart from the third pixel PX3 in the first direction DR1 by three times the width w of the third pixel PX3 in the first direction DR1. In other words, the branch gate line BGL3a may extend by a fourth distance d4 toward the gate driver 120 in FIG. 14 compared to FIG. 7. As a region where the coupling occurs is further away from the third pixel PX3, the effect of the electric field caused by the electrostatic charge accumulated in the branch gate line BGL3b on the eighth transistor T8 may be further reduced. Experimentally, the strength of the electric field measured at the eighth transistor T8 is reduced by about 83.2% in FIG. 14 compared to FIG. 7.

The first cut portion CS1 of the fourth gate line GL4 may be spaced apart from the third pixel PX3 by a fourth distance d4 in the first direction DR1. For example, the first cut portion CS1 of the fourth gate line GL4 may be spaced from the third pixel PX3 by three times the size or width of the third pixel PX3 in the first direction DR1. For example, the first cut portion CS1 of the fourth gate line GL4 may be spaced apart from the third pixel PX3 in the first direction DR1 by three times the width w of the third pixel PX3 in the first direction DR1. In other words, the branch gate line BGL4a may extend by a fourth distance d4 toward the gate driver 120 in FIG. 14 compared to FIG. 7. As a region where the coupling occurs is further away from the third pixel PX3, the effect of the electric field caused by the electrostatic charge accumulated in the branch gate line BGL4b on the ninth transistor T9 may be further reduced. Experimentally, the intensity of the electric field measured at the ninth transistor T9 is reduced by about 84.5% in FIG. 14 compared to FIG. 7.

The first cut portion CS1 of the fifth gate line GL5 may be spaced apart from the third pixel PX3 by a fourth distance d4 in the first direction DR1. For example, the first cut portion CS1 of the fifth gate line GL5 may be spaced from the third pixel PX3 by three times the size or width of the third pixel PX3 in PX3 first direction DR1. For example, the first cut portion CS1 of the fifth gate line GL5 may be spaced apart from the third pixel PX3 in PX3 first direction DR1 by three times the width w of the third pixel PX3 in PX3 first direction DR1. In other words, the branch gate line BGL5a may extend by a fourth distance d4 toward the gate driver 120 in FIG. 14 compared to FIG. 7. As a region where the coupling occurs is further away from the third pixel PX3, the effect of the electric field caused by the electrostatic charge accumulated in the branch gate line BGL5b on the seventh transistor T7 may be further reduced. Experimentally, the strength of the electric field measured at the seventh transistor T7 is reduced by about 36.6% in FIG. 14 compared to FIG. 7.

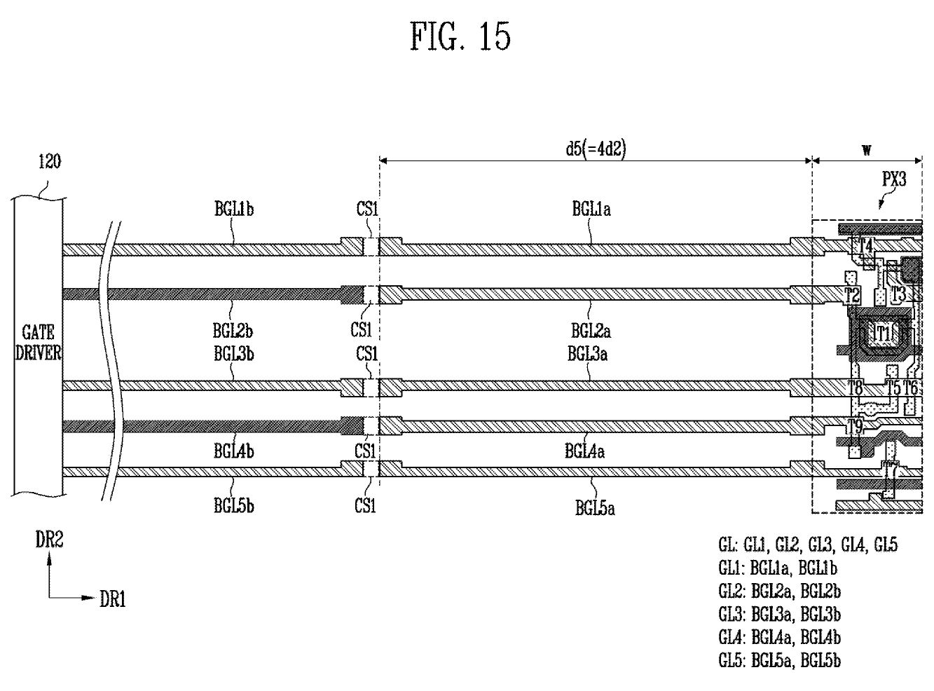

Referring to FIG. 15, the first cut portion CS1 of the first gate line GL1 may be spaced apart from the third pixel PX3 by a fifth distance d5 in the first direction DR1. The fifth distance d5 may be four times the second distance d2 (d5=4d2). For example, the first cut portion CS1 of the first gate line GL1 may be spaced from the third pixel PX3 by four times the size or width of the third pixel PX3 in the first direction DR1. For example, the first cut portion CS1 of the first gate line GL1 may be spaced apart from the third pixel PX3 in the first direction DR1 by four times the width w of the third pixel PX3 in the first direction DR1. In other words, the branch gate line BGL1a may extend by a fifth distance d5 toward the gate driver 120 in FIG. 15 compared to FIG. 7. As a region where the coupling occurs is further away from the third pixel PX3, the effect of the electric field caused by the electrostatic charge accumulated in the branch gate line BGL1b on the fourth transistor T4 may be further reduced. Experimentally, the strength of the electric field measured at the fourth transistor T4 is reduced by about 70.5% in FIG. 15 compared to FIG. 7.

The first cut portion CS1 of the second gate line GL2 may be spaced apart from the third pixel PX3 by a fifth distance d5 in the first direction DR1. For example, the first cut portion CS1 of the second gate line GL2 may be spaced from the third pixel PX3 by four times the size or width of the third pixel PX3 in the first direction DR1. For example, the first cut portion CS1 of the second gate line GL2 may be spaced apart from the third pixel PX3 in the first direction DR1 by four times the width w of the third pixel PX3 in the first direction DR1. In other words, the branch gate line BGL2a may extend by a fifth distance d5 toward the gate driver 120 in FIG. 15 compared to FIG. 7. As a region where the coupling occurs is further away from the third pixel PX3, the effect of the electric field caused by the electrostatic charge accumulated in the branch gate line BGL2b on the second transistor T2 may be further reduced. Experimentally, the strength of the electric field measured at the second transistor T2 is reduced by about 67.0% in FIG. 15 compared to FIG. 7.

The first cut portion CS1 of the third gate line GL3 may be spaced apart from the third pixel PX3 by a fifth distance d5 in the first direction DR1. For example, the first cut portion CS1 of the third gate line GL3 may be spaced from the third pixel PX3 by four times the size or width of the third pixel PX3 in the first direction DR1. For example, the first cut portion CS1 of the third gate line GL3 may be spaced apart from the third pixel PX3 in the first direction DR1 by four times the width w of the third pixel PX3 in the first direction DR1. In other words, the branch gate line BGL3a may extend by a fifth distance d5 toward the gate driver 120 in FIG. 15 compared to FIG. 7. As a region where the coupling occurs is further away from the third pixel PX3, the effect of the electric field caused by the electrostatic charge accumulated in the branch gate line BGL3b on the eighth transistor T8 may be further reduced. Experimentally, the strength of the electric field measured at the eighth transistor T8 is reduced by about 85.5% in FIG. 15 compared to FIG. 7.

The first cut portion CS1 of the fourth gate line GL4 may be spaced apart from the third pixel PX3 by a fifth distance d5 in the first direction DR1. For example, the first cut portion CS1 of the fourth gate line GL4 may be spaced from the third pixel PX3 by four times the size or width of the third pixel PX3 in the first direction DR1. For example, the first cut portion CS1 of the fourth gate line GL4 may be spaced apart from the third pixel PX3 in the first direction DR1 by four times the width w of the third pixel PX3 in the first direction DR1. In other words, the branch gate line BGL4a may extend by a fifth distance d5 toward the gate driver 120 in FIG. 15 compared to FIG. 7. As a region where the coupling occurs is further away from the third pixel PX3, the effect of the electric field caused by the electrostatic charge accumulated in the branch gate line BGL4b on the ninth transistor T9 may be further reduced. Experimentally, the intensity of the electric field measured at the ninth transistor T9 is reduced by about 86.1% in FIG. 15 compared to FIG. 7.

The first cut portion CS1 of the fifth gate line GL5 may be separated from the third pixel PX3 by a fifth distance d5 in the first direction DR1. For example, the first cut portion CS1 of the fifth gate line GL5 may be spaced from the third pixel PX3 by four times the size or width of the third pixel PX3 in the first direction DR1. For example, the first cut portion CS1 of the fifth gate line GL5 may be spaced apart from the third pixel PX3 in the first direction DR1 by four times the width w of the third pixel PX3 in the first direction DR1. In other words, the branch gate line BGL5a may extend by a fifth distance d5 toward the gate driver 120 in FIG. 15 compared to FIG. 7. As a region where the coupling occurs is further away from the third pixel PX3, the effect of the electric field caused by the electrostatic charge accumulated in the branch gate line BGL5b on the seventh transistor T7 may be further reduced. Experimentally, the intensity of the electric field measured at the seventh transistor T7 is reduced by about 40.5% in FIG. 15 compared to FIG. 7.

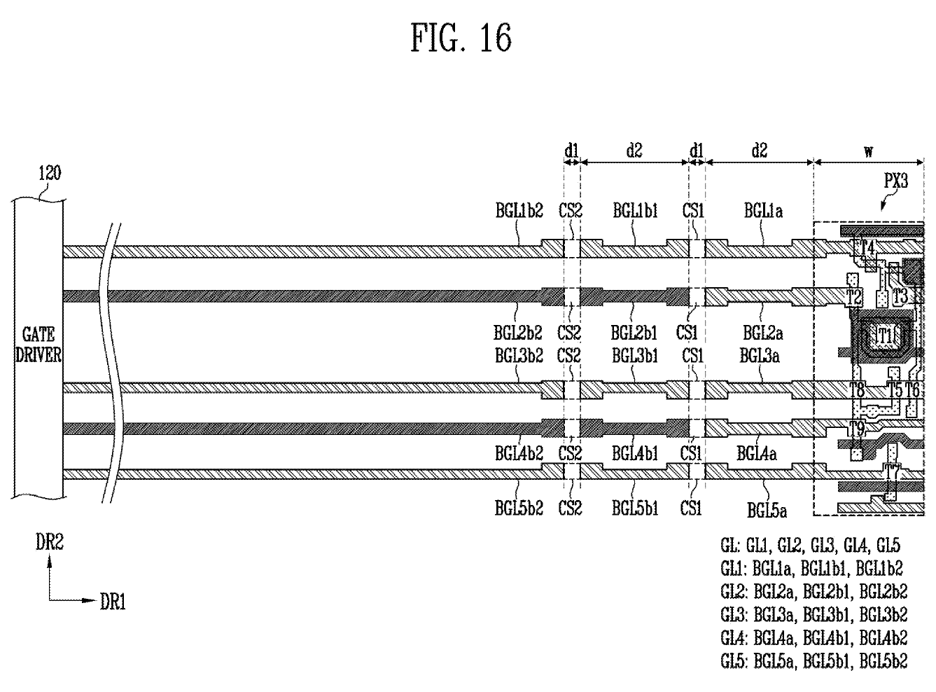

FIG. 16 schematically illustrates a gate line according to some embodiments of the present disclosure. In FIG. 16, previously described content is briefly explained or omitted.

Referring to FIG. 16, the structure shown in FIG. 8 and the structure shown in FIG. 12 may be implemented in combination. For example, the first gate line GL1 may include a first cut portion CS1 and a second cut portion CS2, and the first cut portion CS1 of the first gate line GL1 may be spaced apart from the third pixel PX3 by a second distance d2. For example, the second gate line GL2 includes a first cut portion CS1 and a second cut portion CS2, and the first cut portion CS1 of the second gate line GL2 may be spaced apart from the third pixel PX3 by a second distance d2. For example, the third gate line GL3 includes a first cut portion CS1 and a second cut portion CS2, and the first cut portion CS1 of the third gate line GL3 may be spaced apart from the third pixel PX3 by a second distance d2. For example, the fourth gate line GL4 includes a first cut portion CS1 and a second cut portion CS2, and the first cut portion CS1 of the fourth gate line GL4 may be spaced apart from the third pixel PX3 by a second distance d2. For example, the fifth gate line GL5 includes a first cut portion CS1 and a second cut portion CS2, and the first cut portion CS1 of the fifth gate line GL5 may be spaced apart from the third pixel PX3 by a second distance d2. Accordingly, the influence of the electric field may be reduced, and the suppression of the coupling may be enhanced. As a result, damage to the second transistor T2, the fourth transistor T4, the seventh transistor T7, the eighth transistor T8, and the ninth transistor T9 may be more effectively reduced or prevented. However, embodiments are not limited thereto. For example, any one of the structures illustrated in FIGS. 8 - 11 and any one of the structures illustrated in FIGS. 12 - 15 may be implemented in combination.

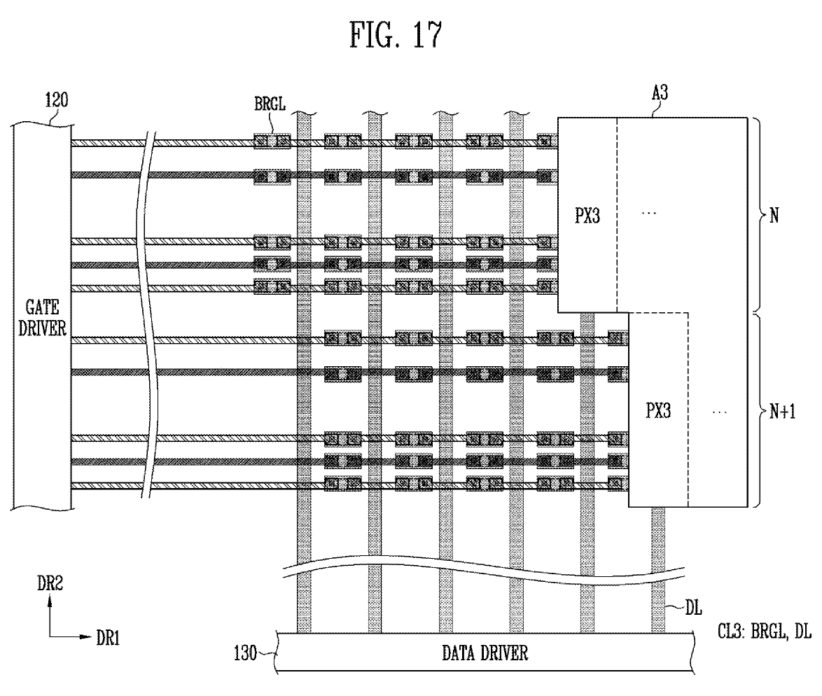

FIG. 17 schematically illustrates gate lines and data lines according to some embodiments of the present disclosure.

In FIG. 17, two third pixels PX3 are shown located at the outermost portion of the third display area A3. For example, one of the two third pixels PX3 may be located in a row N, and the other of the two third pixels PX3 may be located in a row N+1. Each of the two third pixels PX3 may be connected to the gate line GL shown in FIG. 11. In FIG. 17, a third conductive layer CL3 is further illustrated, which is located on the second conductive layer CL2 (see FIG. 6). For convenience, in FIG. 17, the reference symbols shown in FIG. 11 are omitted.

Referring to FIG. 17, the third conductive layer CL3 may include bridge gate lines BRGL and data lines DL. The bridge gate lines BRGL may each connect adjacent branch gate lines via contact holes. For example, one of the bridge gate lines BRGL may connect the branch gate lines BGL1b1 and BGL1b2a (see FIG. 11) via contact holes. Accordingly, gate signals output from the gate driver 120 may be delivered to the third pixel PX3 via the first to fifth gate lines GL1 to GL5 (see FIG. 11), respectively.

The adjacent cut portions may be spaced apart in the first direction DR1 by a second distance d2 (see FIG. 11) (or the size or width of the third pixel PX3). For example, the first cut portion CS1 (see FIG. 11) and the second cut portion CS2 (see FIG. 11) may be spaced apart by a second distance d2 (see FIG. 11) in the first direction DR1. This is to reduce or prevent the likelihood of short circuits between data lines DL and bridge gate lines BRGL located in the same layer. As shown in FIG. 17, the data lines DL and the bridge gate lines BRGL may not overlap each other and may be electrically isolated, as the cut portions adjacent to each other are spaced apart by the size or width of the third pixel PX3.

Although it has been described above that the first to fifth gate lines GL1 to GL5 connected to the third pixels PX3 located at the outermost edge of the third display area A3 include two or more cut portions, embodiments are not necessarily limited thereto. For example, the gate lines GL (see FIG. 1) connected to the pixels PX (see FIG. 1) located at the outermost edge of the first display area A1 (see FIG. 1) and/or the second display area A2 (see FIG. 1) may also include two or more cut portions. That is, certain gate lines GL (see FIG. 1) may have a relatively large area (or length) depending on the atypical shape of the display 110 (see FIG. 1). In such structures, excessive static electricity may be introduced, and accordingly, the corresponding gate lines GL (see FIG. 1) may include two or more cut portions to induce static dissipation (or reduction).

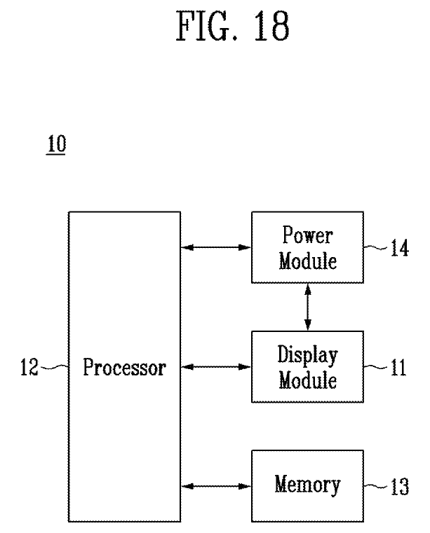

FIG. 18 schematically illustrates an electronic device according to some embodiments of the present disclosure.

Referring to FIG. 18, the electronic device 10 may include a display module 11, a processor 12, a memory 13, and a power module 14.

The processor 12 may include at least one of a central processing unit (CPU), an application processor (AP), a graphics processing unit (GPU), a communication processor (CP), an image signal processor (ISP), or a controller.

The memory 13 may store data information suitable for operation of the processor 12 or the display module 11. When the processor 12 executes an application stored in the memory 13, image data signals and/or input control signals may be delivered to the display module 11, and the display module 11 may process the received signals to output image information via the display screen.

The power module 14 may include a power supply module, such as a power adapter or a battery unit, and a power conversion module that converts the power supplied by the power supply module to generate the power suitable for operation of the electronic device 10.

At least one of the above-described configurations of the electronic device 10 may be included within the display device according to the above-described embodiments. In addition, some of the functionally separate modules may be included within the display device and others may be provided separately from the display device. For example, the display device may include the display module 11, while the processor 12, the memory 13, and the power module 14 may be provided in the form of other devices within the electronic device 10 other than the display device.

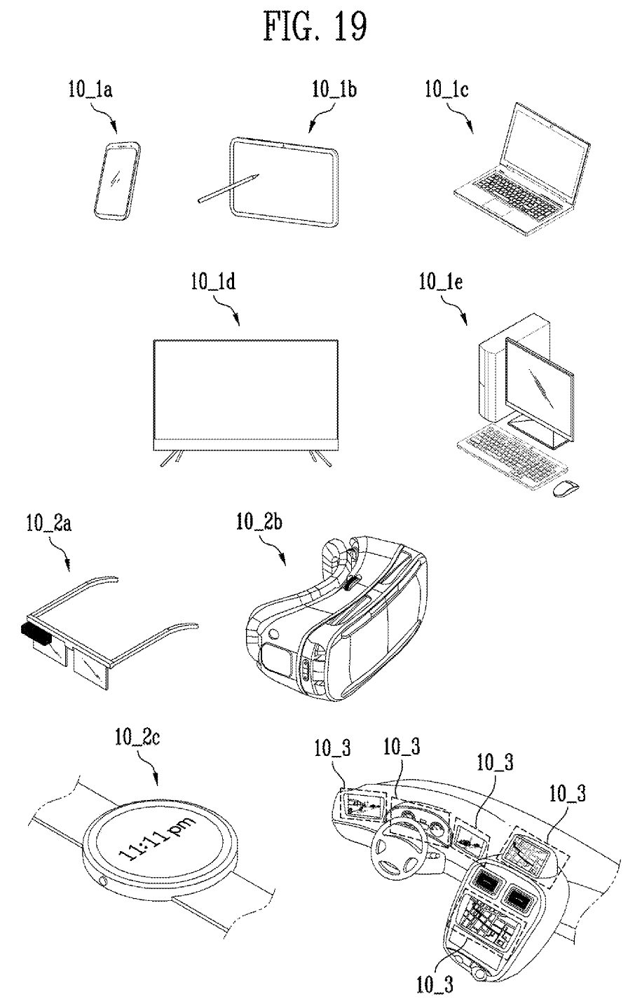

FIG. 19 schematically illustrates electronic devices according to some embodiments of the present disclosure.

Referring to FIG. 19, the electronic device 10 (see FIG. 18) may include an electronic device for displaying images, such a as a smartphones 10_1a, a tablet PC 10_1b, a laptop 10_1c, a television 10_1d, a desk monitor 10_1e, as well as a wearable electronic device including a display module, such as a smart glasses 10_2a, a head-mounted display 10_2b, a smart watch 10_2c, and the like, and an automotive electronic device 10_3 including a display module, such as a center information display (CID), a room mirror display, and the like located on an instrument panel, a center fascia, or a dashboard of an automobile.

According to a display device and an electronic device including the display device according to embodiments of the present disclosure, in case that the display is implemented in an atypical shape, damage to the transistors located at the outermost edge of the display by static electricity flowing into the gate lines having a large area may be reduced or prevented.

The foregoing referenced drawings and detailed descriptions of the present disclosure are mere examples of the present disclosure and are intended to illustrate the present disclosure, but are not intended to limit the meaning or to restrict the scope of the present disclosure as claimed in the appended claims. Accordingly, those skilled in the art will understand that various modifications and other equivalent embodiments can be made from the foregoing referenced drawings and detailed descriptions. The true scope of technical protection of the present disclosure should therefore be determined by the technical spirit of the appended claims, and their equivalents.

What is claimed is:

1. A display device, comprising:
a display comprising a first display area comprising a first pixel, a second display area comprising a second pixel, and a third display area comprising a third pixel; and
a gate driver connected to the first pixel, to the second pixel, and to the third pixel via gate lines comprising a first gate line, a second gate line, a third gate line, a fourth gate line, and a fifth gate line defining two or more cut portions, extending in a first direction, and arranged along a second direction crossing the first direction, one of the gate lines connected to the third pixel having a longest length of the gate lines.

2. The display device according to claim 1, wherein the third pixel is at an outermost edge of the third display area facing the gate driver.

3. The display device according to claim 1, wherein the first gate line, the second gate line, the third gate line, the fourth gate line, and the fifth gate line comprise three or more branch gate lines respectively separated by the two or more cut portions.

4. The display device according to claim 3, wherein the three or more branch gate lines are separated by about 5μm to about 15μm in the first direction.

5. The display device according to claim 4, wherein the two or more cut portions are spaced apart in the first direction by a distance corresponding to a dimension of the third pixel.

6. The display device according to claim 1, wherein a cut portion farthest from the gate driver among the two or more cut portions is adjacent to the third pixel.

7. The display device according to claim 1, wherein a cut portion farthest from the gate driver among the two or more cut portions is separated from the third pixel in the first direction by distance corresponding to a multiple of a dimension of the third pixel.

8. A display device, comprising:
a display comprising a first display area comprising a first pixel, a second display area comprising a second pixel, and a third display area comprising a third pixel; and
a gate driver connected to the first pixel, to the second pixel, and to the third pixel via gate lines comprising a first gate line, a second gate line, a third gate line, a fourth gate line, and a fifth gate line respectively defining a first cut portion and a second cut portion, extending in a first direction, and arranged along a second direction crossing the first direction, one of the gate lines connected to the third pixel having a longest length.

9. The display device according to claim 8, wherein the first gate line, the second gate line, the third gate line, the fourth gate line, and the fifth gate line comprise three branch gate lines separated by the first cut portion and the second cut portion.

10. The display device according to claim 9, wherein the first gate line, the second gate line, the third gate line, the fourth gate line, and the fifth gate line further define a third cut portion.

11. The display device according to claim 10, wherein
the first gate line, the second gate line, the third gate line, the fourth gate line, and the fifth gate line comprise four branch gate lines respectively separated by the first cut portion, the second cut portion, and the third cut portion.

12. The display device according to claim 10, wherein the first gate line, the second gate line, the third gate line, the fourth gate line, and the fifth gate line further comprise a fourth cut portion.

13. The display device according to claim 12, wherein the first gate line, the second gate line, the third gate line, the fourth gate line, and the fifth gate line comprise five branch gate lines respectively separated by the first cut portion, the second cut portion, the third cut portion, and the fourth cut portion.

14. The display device according to claim 12, wherein the first gate line, the second gate line, the third gate line, the fourth gate line, and the fifth gate line further comprise a fifth cut portion.

15. The display device according to claim 14, wherein the first gate line, the second gate line, the third gate line, the fourth gate line, and the fifth gate line comprise six branch gate lines respectively separated by the first cut portion, the second cut portion, the third cut portion, the fourth cut portion, and the fifth cut portion.

16. The display device according to claim 8, wherein the first cut portion is farthest from the gate driver and adjacent to the third pixel.

17. The display device according to claim 8, wherein the first cut portion is farthest from the gate driver and is separated from the third pixel by a distance corresponding to a multiple of a dimension of the third pixel in the first direction.

18. The display device according to claim 8, wherein the third pixel comprises:
a first transistor connected between a first node and a second node, and having a gate electrode connected to a third node;
a second transistor connected between the first node and a data line, and having a gate electrode connected to the second gate line;
a third transistor connected between the second node and the third node, and having a gate electrode connected to the second gate line;
a fourth transistor connected between the third node and a first initialization line, and having a gate electrode connected to the first gate line;
a fifth transistor connected between a fourth node and a first power line, and having a gate electrode connected to the third gate line;
a sixth transistor connected between the second node and a fifth node, and having a gate electrode connected to the third gate line;
a seventh transistor connected between the fifth node and a second initialization line, and having a gate electrode connected to the fifth gate line;
an eighth transistor connected between the first node and the fourth node, and having a gate electrode connected to the third gate line;
a ninth transistor connected between the fourth node and a third power line, and having a gate electrode connected to the fourth gate line;
a capacitor connected between the third node and the fourth node; and
a light-emitting element connected between the fifth node and a second power line.

19. The display device according to claim 18, wherein, in a plan view, the second transistor, the fourth transistor, the seventh transistor, the eighth transistor, and the ninth transistor are at an outermost edge of the third pixel facing the gate driver.

20. An electronic device, comprising:
a processor configured to provide input image data; and
a display device configured to display images based on the input image data, and comprising:
a display comprising a first display area comprising a first pixel, a second display area comprising a second pixel, and a third display area comprising a third pixel; and
a gate driver connected to the first pixel, to the second pixel, and to the third pixel via gate lines comprising a first gate line, a second gate line, a third gate line, a fourth gate line, and a fifth gate line defining two or more cut portions, extending in a first direction, and arranged along a second direction crossing the first direction, one of the gate lines connected to the third pixel having a longest length.
